(19) United States
(12) Patent Application Publication
(10) Pub. No.: US 2022/0156754 A1
(43) Pub. Date: May 19, 2022

(54) SECURE TOKEN-BASED EXCHANGE OF POLLUTION CREDITS FOR THE REDUCTION OF WORLDWIDE POLLUTION

(71) Applicant: Planet Savings Inc., Cambridge, MA (US)

(72) Inventors: Robert S. MacArthur, Cambridge, MA (US); Brian A. Bauer, Somerville, MA (US)

(21) Appl. No.: 17/441,379

(22) PCT Filed: Mar. 26, 2020
(86) PCT No.: PCT/US2020/024815

§ 371 Date: Sep. 21, 2021

Related U.S. Application Data
(60) Provisional application No. 62/823,985, filed on Mar. 26, 2019.

(51) Int. Cl. G06Q 30/00; G06Q 20/38

(52) U.S. Cl. CPC G06Q 30/018; G06Q 30/0215; G06Q 20/389

(57) ABSTRACT

In one embodiment, a computing device may receive carbon emissions acquisition data indicative of an allowance of carbon emissions. The computing device may generate token data based on the received carbon emissions acquisition data, wherein the token data is associated with a portion of the allowance of carbon emissions and includes a use indicator and an ownership indicator. The computing device may store the token data to a distributed transaction ledger, wherein a redemption transaction that updates the distributed transaction ledger is configured to alter the use indicator of the token data.

### RELATED APPLICATION

This application is a U.S. National Stage Application of PCT/US2020/024815, filed Mar. 26, 2021, which claims priority to U.S. Provisional Patent Application No. 62/823,985, filed on Mar. 26, 2019, both entitled “SECURE TOKEN-BASED EXCHANGE OF POLLUTION CREDITS FOR THE REDUCTION OF WORLDWIDE POLLUTION” by MacArthur et al., the contents of each which are incorporated by reference herein.

### TECHNICAL FIELD

The present disclosure relates generally to pollution reduction and, more particularly, to a secure token-based exchange of pollution credits for the reduction of worldwide pollution, where secure tokens may each include a use indicator and an ownership indicator.

### BACKGROUND

Pollution, emissions, global warming, and other environmental issues continue to gain media exposure and public awareness. In particular, climate change is a threat to humanity. Science has established that excessive carbon dioxide in the atmosphere is the prime cause for global warming and that carbon dioxide is a result of human activity.

There is a need for commerce and industry as well as the public to address climate change with every means available to prevent catastrophic consequences. The public and, in particular, consumers have heretofore had little means to reducing the carbon footprint other than by changing their behavior or paying for it by donating to non-profits focused on the environment. These means are not only inconvenient, but they can result in extra costs to the consumer.

Some consumers may purchase products or services based on how environmentally friendly or “green” they perceive the manufacturer and/or seller of the product or service to be. Further, some of those consumers are willing to pay a premium price for doing so. Products may be marketed as being “green” in an attempt to woo consumers. The environmental benefit of buying an existing “green” product or service, however, is not precisely quantified. A consumer has no way to know how much a given purchase may benefit the environment, if indeed it does so at all. Consumers may be wary of overblown marketing claims (or “greenwashing”) but may not be able to invest the time, energy, or money in researching a “green” marketing claim to determine its authenticity. Many such skeptical consumers may be reluctant to choose a “green” product, even if it is the same price as another, similar product.

New markets in the sale of pollution/emission credits are emerging in an attempt to provide economic incentives to reduce pollution. A cap and trade market, for example, enables a low-polluting entity to sell unused pollution credits to a high-polluting entity, thereby providing an incentive to reduce pollution and a penalty for emitting a high amount of pollution. Such markets, however, tend to trade in bulk quantities of pollution credits (e.g., on the order or thousands or millions of pounds of carbon emissions). While an average consumer may desire to contribute to these markets, they are inaccessible to an average consumer.

### SUMMARY

The climate is in crisis. According to one or more embodiments herein, “Planet Saving Tokens” (PSTs) lower carbon footprints by rewarding consumers as they shop, no matter what they buy. “Planet Saving” is a system and method using secure ledger technology (e.g., a blockchain) to convert cap and trade (“C&T”) carbon credit allowances into tokens that enable ordinary citizens to meaningfully lower carbon footprints, while earning benefits. Since businesses struggle to be socially responsible, and consumers are concerned by the lack of climate action, the PSTs create a consumer loyalty/reward plan that reduces carbon dioxide (CO₂) (or other environmental wastes that are causing damage to the environment, for example, methane (CH₄)). In C&T markets, government regulators sell “allowances” at auction to utilities, granting them permission to emit tons of CO₂ above desired and/or regulatory limits for extended periods to allow them time to convert to cleaner energy. The techniques herein involve entering those auctions to buy allowances (also known as offsets or renewable energy certificates (RECs)) and removing them from the market as so-called “permits to pollute.” That is, the techniques herein allow for disruption of the C&T markets by removing carbon allocations so the allocations cannot be used again.

According to one or more embodiments herein, techniques are described to lower carbon footprints with redeemable carbon-reduction tokens (e.g., PSTs) for businesses to use as rewards to gain (and retain) customers and be regarded as socially responsible by linking everyday purchases to CO₂ reduction. The techniques herein fractionalize tons of pollution (e.g., carbon) offsets into PSTs associated with a certain amount of pollution (e.g., two pounds of carbon for each token). The techniques apply secure ledger technology (e.g., a distributed transaction ledger, blockchain, etc.) to each token to democratize the token monitoring process and prevent duplication and fraud with immutable ledgers. PST tokens may then be sold to millions of ordinary citizens around the world, such that a network of merchants worldwide can be established to redeem tokens. For example, merchants may exchange tokens at a rate of sale (e.g., of one per retail dollar) on any goods or services, provide special discounts for token holders, and/or offer special discounts to token holders on the sale on goods or services. Further, each PST may be divided into sub-portions, where one part is permanently attached to the token as a security in the form of tradable asset-backed carbon currency, while the other in the form of a detachable instrument (e.g., as a coupon). Each part of the PST may be tracked and recorded on the distributed transaction ledger based on, respectively, an ownership indicator and a use indicator. Further, an expiration timer may be generated and associated with the use indicator to spur the use of the detachable instrument (the expiration time may be extended only by an administrator of the PSTs).

In greater detail, the techniques herein use PSTs to convert carbon offsets (e.g., purchased by the ton) into smaller increments (e.g., pound-increments) to create redeemable tokens as a form of universal carbon currency for commerce and industry to append to goods and services. The techniques apply a secure distributed transaction ledger (e.g., blockchain) technology to track tokens from source to redemption, track inventories, and prevent fraud with the immutable ledgers. The distributed transaction ledger may be stored and updated by a plurality of computing devices, operated by merchants that participate in the maintenance of the PSTs (i.e., are part of a PST Merchant Network). Merchants use tokens to gain (and retain) customers and be regarded socially responsible with accurate return on investment (ROI). Enterprises, by implementing PSTs into their interactions with consumers, may meet Environmental, Social, and Governance (ESG) goals, United Nations (UN) Global Compact mandates, and/or and Paris Accord climate mandates. The consumer also wins by being a climate-responsible party (that has knowledge that his or purchase has a quantifiable benefit to the environment).

On redemption of a token with a merchant, the token holder (consumer) and the merchant may split the credit for the token, for example, equally (e.g., the consumer gets credit for one pound of carbon reduction per retail dollar of purchase, while the merchant makes a sale and gets credit for the other pound). Other divisions of credit may be used, and an equal split is merely an example. A PST distributed transaction ledger may accumulate token holder activity to provide token holders subsequent benefits, and the merchant builds brand as socially responsible and gets credit toward ESG goals. With sufficient volume, a merchant may never need to buy offsets to comply with the Paris Accord, UN Global Compact, CORSIA and other similar standards.

Alternatively, tokens may be traded or converted into fiat currency (i.e., convertible paper money made legal tender by a government decree) as such markets exist, or token holders can make tax deductible donations to charity. All tokens may be “burned” when redeemed or converted to fiat, thus creating scarcity in the availability of pollution credits. That is, carbon credits are permanently retired when a token is redeemed, and the token holder and merchant each get credit for the redemption (e.g., for one pound of reduction per retail dollar of purchase from merchant network). As is understood in the art, a historical record of a retired token may continue to exist on a distributed transaction ledger.

In one embodiment, in particular, a computing device may receive carbon emissions acquisition data indicative of an allowance of carbon emissions. The computing device may generate token data based on the received carbon emissions acquisition data, wherein the token data is associated with a portion of the allowance of carbon emissions and includes a use indicator and an ownership indicator. The computing device may store the token data to a distributed transaction ledger, wherein a redemption transaction that updates the distributed transaction ledger is configured to alter the use indicator of the token data.

Other specific embodiments, extensions, or implementation details are also described below.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 is a block diagram of a system for reducing pollution in accordance with an embodiment of the invention;

FIG. 2 is a flow chart of a method for reducing pollution in accordance with an embodiment of the invention;

FIG. 3 is a flow chart of a service provider model for distributing points in accordance with an embodiment of the invention;

FIG. 4 is a flow chart of an original-equipment manufacturer (“OEM”) and/or branded product producer model for distributing points for in accordance with an embodiment of the invention;

FIG. 5 is a flow chart of a direct marketer model for distributing points in accordance with an embodiment of the invention;

FIG. 6 is a flow chart of a retail merchant model for distributing points in accordance with an embodiment of the invention;

FIG. 7 illustrates an example architecture for a secure token-based exchange of pollution credits for reduction of worldwide pollution;

FIG. 8 illustrates an example flow chart for a Phase I of PST system;

FIG. 9 illustrates an example flow chart for a Phase II of PST system;

FIG. 10 illustrates an example flow chart for a PST platform;

FIGS. 11-12 illustrate example simplified procedures for a secure token-based exchange of pollution credits for reduction of worldwide pollution; and

FIG. 13 is an example computing device.

### DESCRIPTION OF EXAMPLE EMBODIMENTS

——Merchant-Driven Points-Based System ——

U.S. Pat. No. 8,527,335, entitled “SYSTEM AND METHOD FOR REDUCING POLLUTION”, was filed by R. MacArthur on Jul. 7, 2010, and issued on Sep. 3, 2013 (hereinafter “the '335 patent”). In particular, the '335 patent, the contents of which are incorporated herein in their entirety, described various embodiments of methods, systems, and apparatus for removing pollutants/emissions (in particular, carbon) from the cap-and-trade and other similar markets, thereby contributing to, for example, the lowering of society's carbon footprint. The supply of pollution credits was thereby reduced on the open market, and their cost is increased for use as a counter-balance to the continuing pollution of non-compliant emitters. Consumers benefitted by receiving an opportunity and means to participate in socially responsible buying while receiving tangible and intangible rewards associated with lowering global emissions. Merchants, manufacturers, producers, and service providers may benefit by building customer loyalty, increasing sales, and by capturing consumer-profile data for marketing purposes.

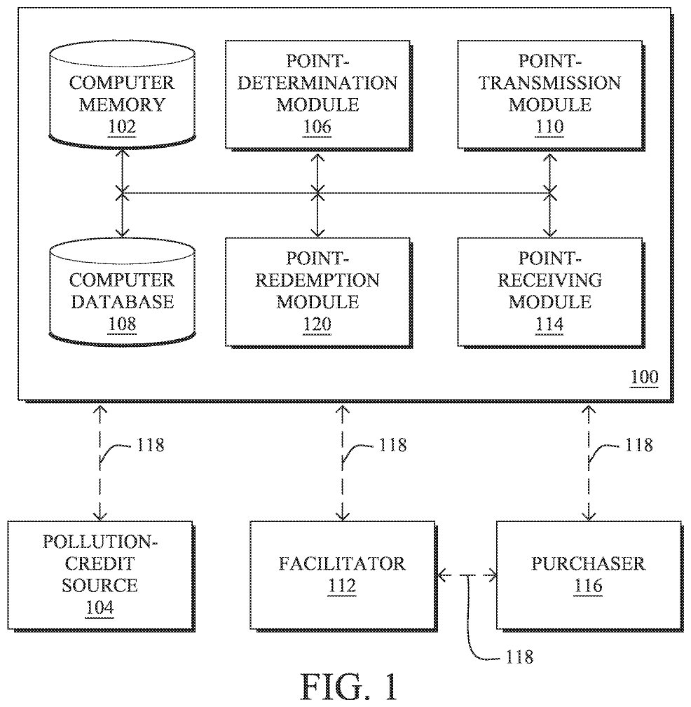

As described in the '335 patent, FIG. 1 illustrates a system 100 for reducing pollution. Computer memory 102 stores a credit representing an amount of pollution. The credit is received from a pollution-credit source 104 such as a pollution emitter, commodity exchange, voluntary market in pollution, regulated market in pollution (e.g., cap-and-trade), or any other similar source. The credit is typically purchased. A point-determination software module 106 determines a credit point value based at least in part on the received credit, and a computer database 108 stores the credit point value. A point-transmission software module 110 tracks sending of points to a point-distribution facilitator 112. The points represent at least a portion of the credit-point value and may be associated with a product or service offered by the facilitator 112 or other entity. A point-receiving software module 114 tracks receipt of a request to redeem the points from a purchaser 116 of the product or service. A point-redemption software module 120 tracks sending of a redemptive value to the purchaser 116 in exchange for the points. The point redemptive value may be pre-set and transferred to a purchaser 116 along with a product or service. The system 100, pollution-credit source 104, facilitator 112, and purchaser 116 may be connected by a communications channel or channels 118. In various embodiments, a communications channel 118 may be a digital computer network, such as the Internet, or a non-digital channel such as a telephone network, U.S. mail, package delivery service, or even an in-person meeting.

The system 100 may be any computing device capable of receiving information/data from and delivering information/data to the pollution-credit source 104, facilitator 112, and purchaser 116. The computer memory 102 and/or the computer database 108 may store computer-readable instructions for execution on the system 100. The system 100 may include a visual display device (e.g., a computer monitor), a data entry device (e.g., a keyboard), a processor, and a mouse. In various embodiments, the system 100 is any type of personal computer, terminal, network computer, wireless device, information appliance, workstation, mini computer, mainframe computer, personal-digital assistant, smart phone, handheld device, or other computing device that capable of both presenting information/data to, and receiving commands from, a user thereof. The channels 118 may be standard telephone lines, LAN or WAN links (e.g., T1, T3, 56 kb, X.25), broadband connections (e.g., ISDN, Frame Relay, ATM), Fiber-Distributed Data Interface (“FDDI”), RS232, IEEE 802.11, IEEE 802.11a, IEEE 802.11b, IEEE 802.11g, or other wireless connections and may use a variety of communication protocols (e.g., HTTP, TCP/IP, IPX, SPX, NetBIOS, NetBEUI, SMB, Ethernet, ARCNET, and direct asynchronous connections).

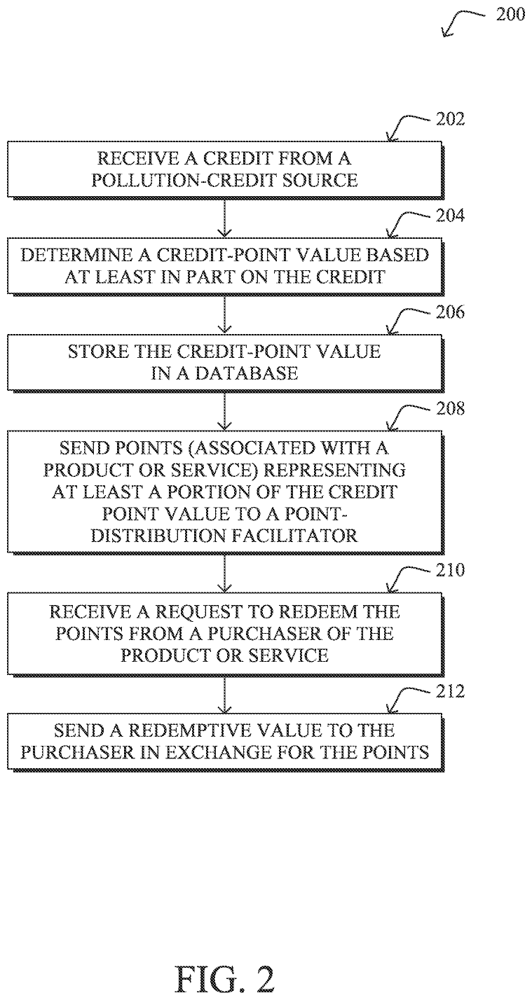

As also described in the '335 patent, FIG. 2 illustrates a method for reducing pollution. In summary, a credit is received from a pollution-credit source (Step 202), and a credit-point value of the credit is determined (Step 204). The credit-point value is stored in a database (Step 206). Points, representing at least a portion of the credit point value, are sent to a point-distribution facilitator (Step 208). A request to redeem the points is received from a purchaser of the product or service (Step 210), and a redemptive value is sent to the purchaser in exchange for the points (Step 212).

In greater detail, in Step 202 a credit is received from a pollution-credit source, which may be a mandatory market (e.g., the Regional Greenhouse Gas Initiative market), a voluntary market (e.g., the Chicago Climate Exchange), a regulated market (e.g., a cap-and-trade market), a pollution emitter, a private company, a municipality, a state or federal government, and/or any other entity that trades in pollution credits. The term “credit” or “pollution credit,” as used herein, refers to any potentially pollution-offsetting commodity, such as a traditional credit or direct purchase of a greenhouse gas (from, e.g., the Chicago Climate Exchange). In one embodiment, the pollution credit is stored in computer memory 102. The pollution credit may represent carbon, carbon dioxide, greenhouse gas, or any other pollutant or emission. The pollution credits may be purchased together in large or small groups, in accordance with any minimum trading size imposed by a market. For example, one or more credits may correspond to a ton of carbon emissions. The pollution credits may be purchased with cash or credit or as commodity futures.

The pollution credits may be validated to assure their legitimacy (e.g., their source and quantity). For example, the source of a pollution credit may be independently contacted to confirm that the credit corresponds to an actual amount of an emitted pollutant and that the pollution credit has not been previously sold. Validation may occur after receipt of the credit (Step 202) and before determining a credit-point value (Step 204). Every pollution credit may be validated, especially in the case of new or unproven credit markets, or a random sampling of credits may be validated. In one embodiment, a third party may be contracted to perform the validation. A special logo or indication may accompany a validated pollution credit (and/or points derived therefrom, as explained further below) to provide assurance that the pollution credit and/or point represents a real pollutant.

Purchased pollution credits may be pooled. The credits may be purchased at different times, in different quantities, and/or from different sources. Adding the different credits to a pool may homogenize them into a more convenient form. For example, the average cost of the pollutant in tons in the pool may be calculated in terms of a cost per pound, and this single cost per pound may be applied to every credit in the pool, regardless of the actual cost of each particular credit. The size of a pool may vary based on the incoming quantity and rate of pollution credits; a maximum pool size may be established, for example, as may a maximum amount of time that a pool may remain open and accepting new pollution credits. A single, large purchase of pollution credits may be divided into a plurality of pools. One or more pools may be open (i.e., accepting new credits) at any given time, and incoming pollution credits may be assigned to different pools having properties similar to the incoming credits.

A credit-point value of a credit or credits may be determined by the point-determination module 106 (Step 204) and stored in the computer database 108 (Step 206). Points may represent a known quantity of pounds of emission credits but are not pollution credits in themselves. Pollution credits, either alone or pooled, may be fractionalized and converted into marketable points. In one embodiment, a dollar of a purchased good or service corresponds to one point, and one point corresponds to one pound of a pollutant (e.g., carbon). Any ratio, however, of dollars to points or of points to quantities of pollution is contemplated by the current invention. Points may be treated as a currency within and among the system 100 and/or distribution models 300, 400, 500, 600, as described below. For example, the purchaser 116 may purchase a product from a first facilitator 112 (e.g., an OEM) and redeem the points associated therewith a second facilitator 112 (e.g., a retail merchant), exchange the points for cash, and/or donate the points to a charity.

A base cost of a point may be determined by calculating the cost per pound of a plurality of credits (in, e.g., a credit pool). Two points may thus represent differing amounts of pollution credits, depending on the purchase price of the pollution credit at the time the points were assigned. The base cost may be marked up to accommodate variations in demand and markets, thereby insuring against a short-term drop in pollutant price. The base cost may be further marked up to generate profits. For example, a point may be obtained at a value of $0.0025 by, e.g., purchasing a metric ton (2,205 pounds) of pollution at a cost of $5.50. The point may be distributed to a facilitator 112, as explained further below, at a price of $0.0045, thereby producing a profit per point of $0.0020, prior to processing and redemption costs (e.g., cash paid to facilitators 112 who present points for redemption 120 and/or from purchasers 116 who present points for redemption).

In one embodiment, the system 100 tracks the creation of points and the pollution credits associated therewith and stores this information in the database 108. Historical point prices may be used to calculate current point markup; e.g., if the price has recently been fluctuating, a greater markup may be assigned to offset the risk of an adverse fluctuation. Each point may be assigned a unique identification code, and this code may accompany the point as it is distributed, as explained further below.

The points may be sent, via the point-transmission module 110 over the communications channel 118, to the facilitator 112 (Step 208). The facilitator 112 may be a manufacturer (e.g., an OEM), a producer of goods, a direct marketer, a service provider, a distributor, and/or a merchant. Other examples of facilitators include brand manufacturers such as appliance manufacturers and cereal companies; service enterprises such as airlines, car rental agencies and hotels/motels; direct markers, both print-mail and Internet; and retail merchants, such as supermarkets and chain stores.

A facilitator 112 may associate points with an offered good or service as an incentive to a consumer (or other downstream purchaser 116). The product or service may indicate, for example, the number or amount of pollution credits that may be retired as a result of purchasing the product or service. The facilitator 112 may employ a logo or slogan on the product or service, or associated with a group or products or services, to advertise the “green” impact of the purchase. The facilitator 112 may set the number of points to be associated with a consumer purchase based on its dollar value (e.g., one point per dollar) or based on other promotional standards (e.g., a fixed point value if the purchase occurs in a given timeframe).

The associated points may be offered in a variety of forms and media. For example, the points may be printed on a paper coupon having a unique identification code, number, or symbol (such as a UPC symbol or bar-coded data). In one embodiment, the points are encoded on an RFID tag or QR code associated with the product or service. The coupon may be bundled with a product or may be printed on the product's packaging. In other embodiments, the points appear as advertising media or are sent as self-mailers. The points may be attached to product warranty cards issued by, e.g., OEMs, or be included in information (such as directions for use) that accompanies consumer products. The points may be printed on service contracts (e.g., car rental agreements, airline tickets, or hotel/motel reservation tickets/forms) or may appear as part of a purchase receipt or register tape. In one embodiment, the points are distributed electronically in, for example, an email or personalized web page or displayed on an e-commerce checkout or confirmation web page. Electronic points may be read, downloaded, printed, and/or forwarded. The electronic points may be associated with credit and or debit card purchases (e.g., as part of a credit/debit card reward program) or incorporated with a merchant's customized “affinity” rewards card (i.e., credit or debit cards sponsored by a merchant or an organization). The electronic points may be displayed by search engine advertisers alongside relevant search results. The term “coupon,” as used throughout this application, may apply to any and all of the aforementioned point distribution mechanisms, as well as other means of distributing points as known in the art.

In one embodiment, the facilitator sells or distributes the points to another provider of products or services instead of to a consumer. In fact, the points may change hands several times before the final sale to a consumer. In various embodiments, pricing models permit facilitators to pay for points “up front” (e.g., as they are distributed) or later, as consumers redeem them (e.g., a “pay for performance” model). In one embodiment, the system 100 tracks the sale and movement of each point and stores this information in the database 108.

Points in a pool may be left unsold if the size of the pool shrinks to an unusable amount or if the points remain unsold for too long a span of time and subsequently expire. Unsold points within a pool may be rolled over to a new pool or may be converted back into their original pollutant form for sale as a commodity in a pollutant-trading market. In one embodiment, a pool is closed when all points in it are sold or expired.

Once a purchaser 116 purchases a product or service associated with the points, the purchaser 116 may send a request to the point-receiving module 114 within the system 100 to redeem the points (Step 210). The request may identify the unique identification code associated with the points, and the point-receiving module 114 may cross-reference the identification code with information stored in the computer database 108. The point-receiving module 114 may reject the request if, for example, the points have been previously redeemed.

The request may be submitted electronically or otherwise. For example, the request may be mailed in via the U.S. mail service or a package delivery service. In one embodiment, the point-receiving module 114 includes a telephone service to which a purchaser may call and communicate the point identification code. The telephone service may be operated by a call center or by an automatic voice menu system. In other embodiments, the request is received via the Internet in the form of an email, web page submission, or through the use of a custom client application.

A purchaser may be required to create a user profile or account with the system 100 before submitting a request to redeem a purchased point. The registration of the user profile may be made by mail, phone, and/or Internet; in one embodiment, however, subsequent interactions are made exclusively over the Internet. Creation of the user profile may require that the purchaser 116 enter identifying information such as name, address, and/or telephone number, and this information may be stored in the computer database 108. The information may be used to validate the purchaser 116 in order to prevent or reduce fraudulent transactions. The purchaser 116 may choose, during registration, to receive news and information about products in which the purchaser 116 has an interest. In one embodiment, the purchaser 116 is given a point award for using a preferred registration mechanism, such as registering via the Internet.

The purchaser's user account may be used to accumulate points for later redemption (as described in more detail below). The system 100 may, upon request, provide an account summary (including points earned) to the purchaser 116. In one embodiment, the point-receiving module 114 may automatically receive a request to accumulate points when a purchaser buys a product or service. For example, the purchaser 116 may receive points from a purchase made over a web site, and the web site may send a request to add the points to the purchaser's account. In another embodiment, the facilitator 112 possesses customized point-of-sale equipment (e.g., a modified credit-card reader) that communicates automatically with the system 100. The purchaser 116 may customize the user account to allow or disallow such automatic point accumulations; the web site may provide this option on a per-purchase basis via, for example, a check box. A purchaser 116 may be encouraged to accumulate points by offering, for example, bonus points at certain levels of accumulation. In one embodiment, a purchaser 116 may purchase more points directly with cash in order to reach, for example, a desired point total.

In one embodiment, the purchaser 116 trades promotional credits received from other entities with the point-receiving module 114 in exchange for points. For example, a purchaser 116 may have an account with an airline and may have accumulated frequent-flier miles. The purchaser 116 may redeem some or all of the frequent-flier miles for a number of points negotiated between the system 100, airline, and/or purchaser 116. For example, the cash value of the frequent-flier miles may be traded for an equivalent cash value of points. The other entity may charge a premium to the purchaser 116 for the transaction in the form of a fee and/or a less-favorable exchange rate. In another example, a purchaser 116 has accumulated promotional credits on an affinity card (i.e., a credit card that earns promotional credits upon use); these credits may also be converted into points.

A point-redemption module 120 sends a redemptive value to the purchaser 116 in exchange for points (Step 212). In one embodiment, a one-time, unregistered purchaser 116 receives the value of every submitted point. In other embodiments, a purchaser 116 has a user account and may redeem some or all of the accumulated points. The redemptive value is sent over the communications channel 118 via mail (e.g., a check, money order, gift certificate, or store coupon) or via the Internet (e.g., an electronic transfer or electronic store credit).

The redemptive value may be cash or credit at one or more of the facilitators 112 originally offering the points or at any other facilitator 112. The credit value may be greater than the cash value offered for the same number of points, in accordance with a request from a facilitator 112, to provide an incentive to the purchaser 116 to opt for the credit and return to the facilitator 112 for further purchases. For example, a purchaser 116 may redeem 1000 points for either $10 of cash or $20 of store credit. In one embodiment, the purchaser 116 redeems points by donating their value to a charity or non-profit enterprise.

If the facilitator 112 has already transferred value to the system 100 in exchange for the points, the point-receiving module 114 may send a corresponding value, in exchange for the points, to the purchaser 116 directly. If, on the other hand, the facilitator 112 has not paid for the points (i.e., the “pay for performance” model described above), the point-receiving module 114 may first send a request to the facilitator 112 for payment commensurate with the redemption request. The point-receiving module 114 may send the redeemed value to the purchaser 116 only when the payment is received from the facilitator 112.

In one embodiment, a purchaser 116 may redeem points directly with a facilitator 112. For example, if the purchaser 116 has already accumulated points with the system 100, and if a facilitator 112 so agrees, the purchaser 116 may apply the previously-accumulated points to a current transaction with the facilitator 112. Thus, the purchaser 116 may receive a discount on a purchase by applying points, or may even be able to purchase a product or service outright using points. In such a transaction, the facilitator 112 may first confirm that the purchaser 116 legitimately possesses the claimed points by querying the database 108 via the communications channel 118. The system 100 may provide verification and, if the transaction is completed, decrement the number of points in the purchaser's account accordingly. The system 100 may require that the facilitator 112 register an account before the system 100 permits the transaction to occur.

As one example, a metric ton (i.e., approximately 2,200 pounds) of carbon dioxide may be translated into 2,200 points. For every dollar of purchase by a purchaser 116, a single point is issued thereto. Thus, a $120.00 purchase rewards the purchaser 116 with 120 points. Each point may be assigned a value of $0.01 by the facilitator 112, so that the $120 purchase earns (rewards) the purchaser 116 the equivalent of $1.20 in discounts on subsequent purchases with the facilitator 112, $1.20 in charitable donations, or $0.60 in cash. In this example, once the purchaser 116 has aggregated 2,200 points (i.e., $2,200 in purchases), the purchaser 116 has removed one metric ton of carbon from the cap-and-trade market, or similar markets where offsets are measured or calculated as sequestered or avoided emissions. Here, the point-purchasing facilitator 112 incurs a cost equal to 1% of sales at retail.

The distribution of points and sale and redemption thereof may be tracked by the system 100. As described above, identifying information such as barcodes, QR codes or RFID tags may be used to garner information about each transaction (printed or electronic) and to permit the capturing and tracking of data. The identifying information may be specific to a single transaction, stock-keeping unit, and/or purchase. Each time a purchaser 116 initiates or completes a transaction, data (e.g., the number of points associated with the transaction) may be collected. Many methods of data collection exist, such as by communicating with point-of-sale equipment, by mailing physical coupons, by fax, via the Internet and/or email, and/or by telephonically providing numeric data inscribed on coupons. The transactional data may be stored in the computer database 108.

The collected data may be mined for demographic and psychographic information and/or buying habits of purchasers 116 and may be sold or rented to third parties (including facilitators 112). Facilitators 112 may purchase the data to track the effectiveness of advertising campaigns, to examine trends in sale frequencies, and/or to control inventory and re-stocking frequency. Third parties may use the collected data for cross-promotions, such as contacting interested purchasers 116 about environmental events or opportunities. Purchasers 116 likely to donate based on the collected data may also be solicited for donations (of cash or points). Other parties interested in purchasing the collected data may include academic institutions, companies involved with clean technology or clean energy, and/or government agencies. In one embodiment, facilitators 112 may pay an additional fee to communicate promotions and offers directly to registered purchasers 116. The system 100 may further use the collected data to prevent fraud by, for example, detecting a purchase out of the ordinary given a particular purchaser's buying history. The collected data, along with any and all other data stored in the system 100 and computer database 108, may be encrypted to prevent accidental discharge thereof.

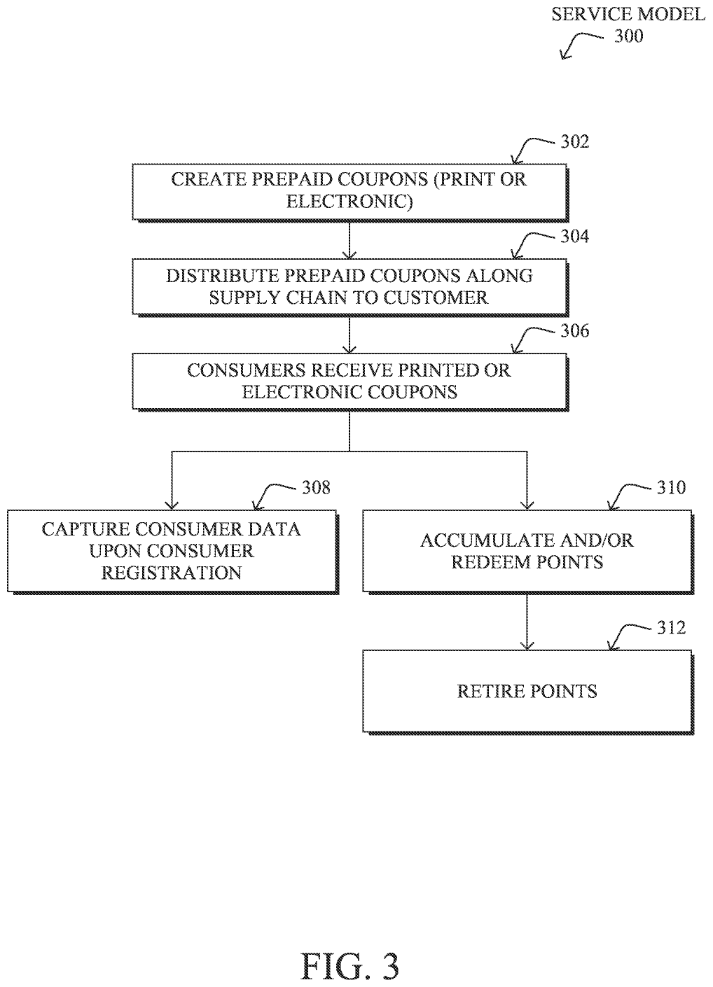

As also described in the '335 patent, FIG. 3 illustrates a service model 300 for distributing points. In this model, service industries (such as the travel and hospitality industries) distribute prepaid coupons, created by the system 100 (Step 302), along a supply chain to a customer (304). In one embodiment, bar codes are used to uniquely identify the points, which may be sold to the service company in pre-numbered blocks. The distributed points may be printed as coupons or directly onto service contracts. In one embodiment, the points are added electronically to the service company's website shopping cart. In an alternative embodiment, the system 100 provides preprinted coupons. The system 100 may send appropriate data to the service provider so that the service provider may print coupon data on its own service contracts or agreements.

Consumers receive the printed or electronic coupons (Step 306) and, as described above, may have to register with the system 100 to accrue and/or redeem them (Step 310). For example, a consumer may redeem points obtained from a single transaction or may accrue points from multiple transactions before redemption. Some or all of the transactional information may be captured by the system 100 for storage (Step 308). Upon registration, the system 100 may notify the service provider, which may contact the consumer (in one embodiment, only with the consumer's permission) to engage in marketing activities such as up-sells or cross sells. Consumers may apply points from their account as a discount against additional purchases (on a basis to be established by the service company). The points used may be automatically decremented or incremented to the consumer's account, depending on the transaction. Newly earned points may not be immediately available for redemption to allow for proper recording, validation, or other operations.

As an example, a customer pre-registered with the system 100 buys an airline ticket having 1,000 points associated with the sale. The travel service issues the points by printing them on the purchased ticket. The points are not immediately available against the cost of that ticket, because the customer must first have them recorded/validated by the system 100. A pre-registered customer, however, may have other points in the system 100 redeemable for the transaction and may apply those points. The system 100 may apply the previously accrued points against the cost of the ticket and later add the points associated with the purchase of the ticket to the consumer's account. A new, unregistered customer may register with the system 100 in order to gain future program benefits associated with the points earned through the purchase of the ticket.

In one embodiment, the service model does not permit a “pay for performance” model, and all point sales must be paid up front. Note that a point distributor may never encounter a consumer returning the points (or any points) as a discount; the points may go unused or may be used at a different service company, used with the purchase of goods, and/or donated to charitable causes. The points may be retired (Step 312) once a redemptive value is conveyed to the consumer.

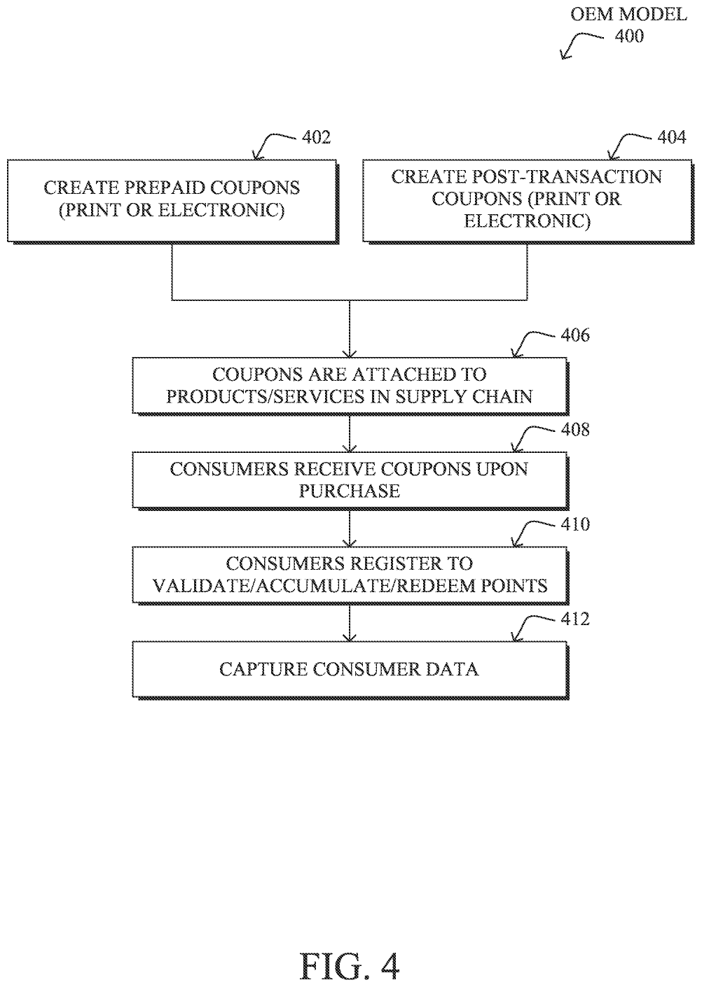

As further described in the '335 patent, FIG. 4 illustrates an OEM model 400 for distributing points. OEMs (and other producers) may buy pre-printed coupons (Step 402) having predetermined point values or may print the coupons themselves (onto, e.g., warranty cards) from a block of assigned numbers. The OEM may award as many or as few points per stock-keeping unit (“SKU”) as they choose. An electronic coupon (for use with in-store or on-line purchases) may be used (Step 404) by accessing a designated web site and entering coded data. The coded data may be a part of printed material that accompanies the merchandise. This electronic option will be available for those purchasing in-store as well as on-line. OEMs may be given the option of paying for the points post customer transaction, but at a significant premium.

The OEM may attach points to products or services in its supply chain (Step 406) but may not conduct a transaction directly with a consumer. Instead, the attached points move down through the supply chain with the product or service, and the OEM may not have further involvement with, e.g., redeeming the points. A consumer receives the points further down the supply chain upon purchasing the product or service (Step 408). In one embodiment, however, the OEM sells directly to consumers, in which case the OEM transacts with the system 100 to verify and redeem the points. As described above, a consumer may register with the system 100 to validate, accumulate, and/or redeem points (Step 410), and once the points are redeemed, they are retired from use. Throughout the OEM model 400, consumer data is captured and stored (Step 412).

In one embodiment, a consumer elects to apply earned points toward payment of an OEM product. The consumer may pay full price then later register the purchase with the system 100. The consumer's account may therefore be decremented a commensurate amount, and the system 100 redeems the appropriate value to the consumer and charges the OEM. In another embodiment, the OEM verifies the existence of points in the consumer's account at the time of sale and decrements the points accordingly.

When a consumer uses the coupons to receive a discount on purchases, the final seller in the supply chain (e.g., a merchant or retailer) may grant the discount and redeem the points with the system 100. Thus, if the retailer did not originally purchase the points from the system 100, the retailer may not pay for the cost of the discount, and may present the redeemed points to be recompensed for the discount offered the consumer. The cost of the points as purchased by the OEM, for example, may be sufficient to allow the system 100 to cover all the costs of redemption.

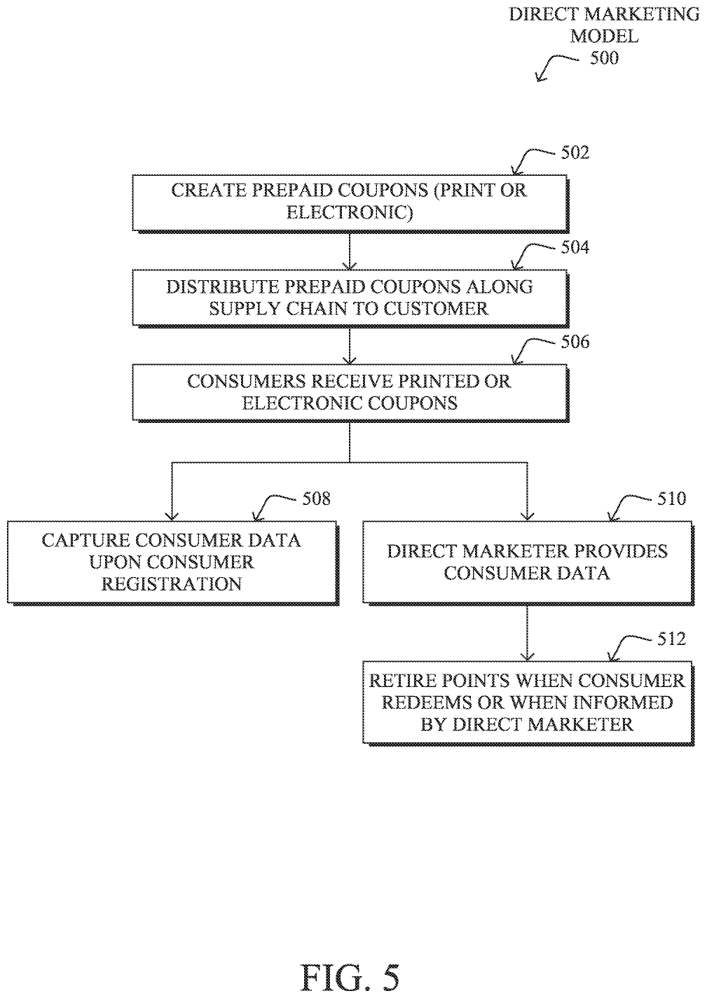

As described in the '335 patent, FIG. 5 illustrates a direct marketer model 500 for distributing points. In one embodiment, only prepaid points are allowed (Step 502), except for marketing programs that prospect for new customers. Prospective customers may be encouraged to register with the system 100 in addition to with the marketer. The prospective customers may have their points registered and the system 100 may charge the marketer therefor.

The direct marketer may distribute the points along the supply chain to potential customers (Step 504) who may receive them in print or electronic form (Step 506). Bar-coded or QR coded points may be printed alongside each displayed SKU or to cover an entire catalog content or web-page content and eventually shown on, e.g., an order blank or shopping cart. Points (bar coded, QR coded, RFID, etc.) may become part of order fulfillment and thus ride along with SKU delivery to the consumer. A direct marketer's order entry and processing systems may be adapted to accommodate discounts based on points redemption or to handle the addition of points to a customer's account. Note, however, that points issued from one channel may not be honored (or honored to a greater or lesser degree) in another channel. For example, consumers may be led from one channel (e.g., retail stores or catalogs) to a more desired one (e.g., a web site) using this mechanism.

As described above, consumer data may be captured upon registration or at any other time (Step 508). The direct marketer may also provide any other consumer data (gathered, for example, though other means) to the system 100 (Step 510). The points may be retired when the consumer redeems them or when the system 100 is so informed by the direct marketer (Step 512). Direct marketers may be informed each time one of their customers registers or engages in a points transaction, and may be informed, for a fee, of total banked points balances for those customers. Customers having a high points total may be more likely to respond favorably to a request from the direct marketer. In one embodiment, direct marketers may rent names from the system 100 (for a fee) to engage in marketing campaigns of their own design.

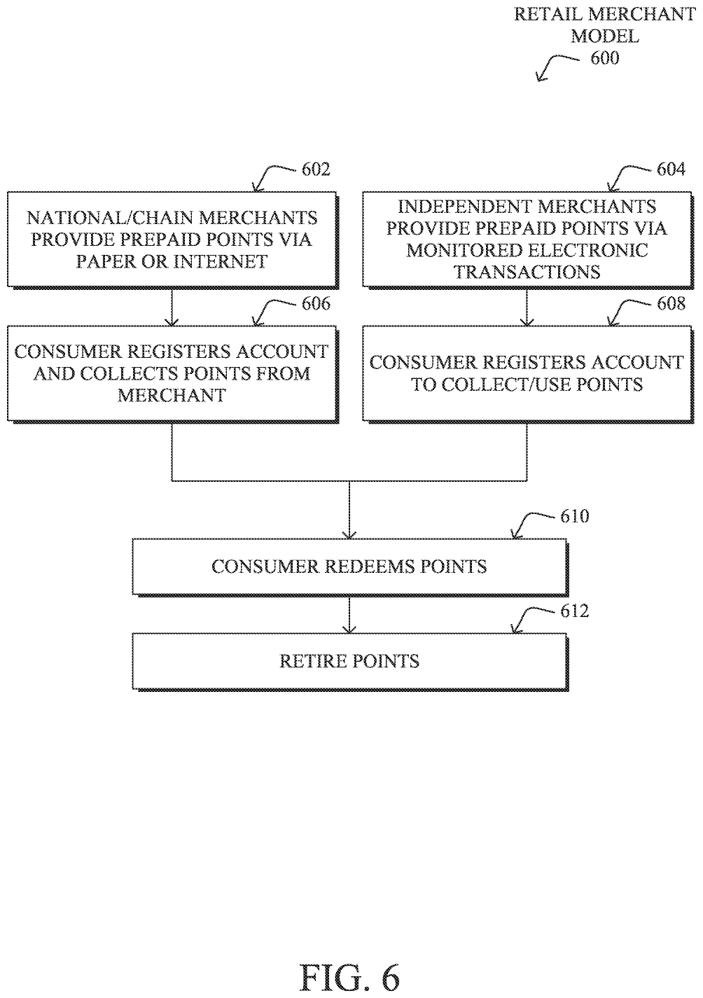

Lastly, as described in the '335 patent, FIG. 6 illustrates a retail merchant model 600 for distributing points. National or chain merchants (e.g., supermarkets and department stores) may provide prepaid points via bar-coded print or electronic coupons, store affinity cards, or register tapes (Step 602). Smaller, independent merchants may be restricted to providing prepaid points only electronically in order to verify each sale (Step 604). Any paper-based coupons may need to be scanned or otherwise electronically read, and subsequently transmitted to the system 100, in order to be associated with a particular sale. Note that a product offered by the merchant may already be bundled with paper- or electronic-based points; the merchant need not scan and transmit these points, because the upstream bundler has already done so.

A consumer may collect points from the national/chain merchant (Step 606) but may have to register with the system 100 in order to collect or use points received from the independent merchant (Step 608). In other words, national/chain merchants may manage their customer accounts without having to report every transaction to the system 100 (until a point redemption is requested). In either case, the consumer must be registered with the system 100 to redeem points (Step 610), and the points are retired upon redemption (Step 612). Merchants may honor coupons (from any facilitator) presented by consumers for redemption in merchandise, as long as the consumer is registered with the system 100. In one embodiment, merchants load their own affinity cards with points. In another embodiment, a point-compatible affinity card may be used with any facilitator.

——Secure Token-Based Exchange of Pollution Credits for Reduction of Worldwide Pollution ——

The techniques herein newly introduce a system for “Planet Saving Tokens” (PSTs), which are increments of bulk tons of carbon dioxide offsets, allowances and credits. For example, a PST may be associated with 1,000th of a metric ton of CO₂. As described in detail below, PSTs:
lower the carbon footprint by removing and retiring carbon credits from markets where they are sold to commercial and industrial enterprises (mostly utilities) as allowances to continue operating above desired environmental standards (caps)—which can be regarded as permits to pollute;
support beneficial climate action and practices;
allow the public to easily participate in commercial C&T markets without major purchasing commitments;
allow consumers to make measurable impact in climate change without friction or changing daily habits;
allow the public to speculate on future increases in the value of offsets
have economic value when redeemed by merchants seeking customers and/or to be regarded socially responsible by meeting Corporate Social Responsibility (CSR) criteria and Environment, Social, and Governance (ESG) goals;
may be traded where markets exist for them or donated to charities; and
may be converted into fiat as such markets exist.

By way of additional background, global warming is an escalating world risk created and exacerbated by the practices of commerce, industry, and agriculture. It is a humanitarian issue affecting the health of individuals, societies, countries, land masses, oceans, indeed the entire planet. The public is frustrated by its inability to influence meaningful environmental policies, and finds it especially difficult to generate significant impact, although it is being asked to do so by commercial enterprises—the very ones creating the problems, but externalizing responsibility for action. There is increasing urgency as the impact becomes more personal. Consumers are admonished daily to change their behavior to benefit the planet. Advocacy groups demonstrate their frustration and march for enlightened environmental policies.

Compounding the burden, non-profit organizations constantly solicit donations from the public to help them influence commercial practices to bring carbon reduction, water conservation, waste into line. Something is wrong and needs a new approach. It is time to reward consumers for environmental action, not punish them by making them pay for problems they did not create, and over which have little control.

The techniques herein, therefore, provide a centralized controller (e.g., central database, server, application, system, etc.) and distributed transaction ledger that may use certain aspects of the '335 patent above, to create a mission-oriented consumer reward platform that lowers the carbon footprint by linking everyday purchases to CO₂ reductions even if the purchase-content is not considered ‘green’. Consumers can create direct and measurable impact, get a psychic uplift, and gain monetarily as well. The techniques herein convert commercial carbon offsets, allowances and credits into digital Tokens (the “PST”). Tokens become decentralized fractions of CO₂ tons (standard short tons or metric) that can have value in promoting goods and services. The '335 patent above uses this type of system in marketing points, and will be converted to create a gateway for Tokens in public hands that merchants can redeem or purchase as needed to market their goods and services, burning all Tokens acquired and redeemed.

Enterprises will be able to purchase tokens to satisfy their climate mission and responsibility goals. This allows the flexibility to pass fractionalized portions of bulk Offsets in token form to employees (even stockholders) or to use them in marketing their goods and services. It makes the enterprise “look good” and their customers “feel good.” The platform herein allows enterprises to accurately measure ROI in connection with their sustainability, ESG and CSR initiatives. Reports can be prepared for Directors and Shareholders.

Specifically, CO₂ offsets may be treated as a decentralized environmental-asset that can legitimately claim carbon remediation without duplication or fabrication, using the secure ledger-based token system described herein. Notably, the creation of ledger-based tokens should not use any blockchain techniques that require energy-intensive mining or has slow transactional speeds. Current examples of such techniques as offered by STELLAR, ZILLIQA, TANGLE, RADIX, and so on. (In other words, expending energy resources to create tokens would effectively negate the purpose of Planet Saving Tokens (PSTs).)

According to one or more embodiments of the disclosure, techniques herein provide for secure token-based exchange of pollution credits for the reduction of worldwide pollution. In one specific embodiment, a computing device may receive carbon emissions acquisition data indicative of an allowance of carbon emissions. The computing device may generate token data based on the received carbon emissions acquisition data, wherein the token data is associated with a portion of the allowance of carbon emissions and includes a use indicator and an ownership indicator. The computing device may store the token data to a distributed transaction ledger, wherein a redemption transaction that updates the distributed transaction ledger is configured to alter the use indicator of the token data.

In another embodiment, a computing device may receive a distributed transaction ledger comprising a plurality of token data, wherein each of the plurality of token data is associated with a portion of an allowance of carbon emissions and includes a use indicator and an ownership indicator. The computing device may determine that a redemption transaction is associated with a particular portion of the allowance of carbon emissions. The computing device may propose an update to the distributed transaction ledger that alters the use indicator of a particular token data associated with the particular portion from the redemption transaction. The computing device may alter the use indicator of the particular token data in response to an acceptance of the update to the distributed transaction ledger.

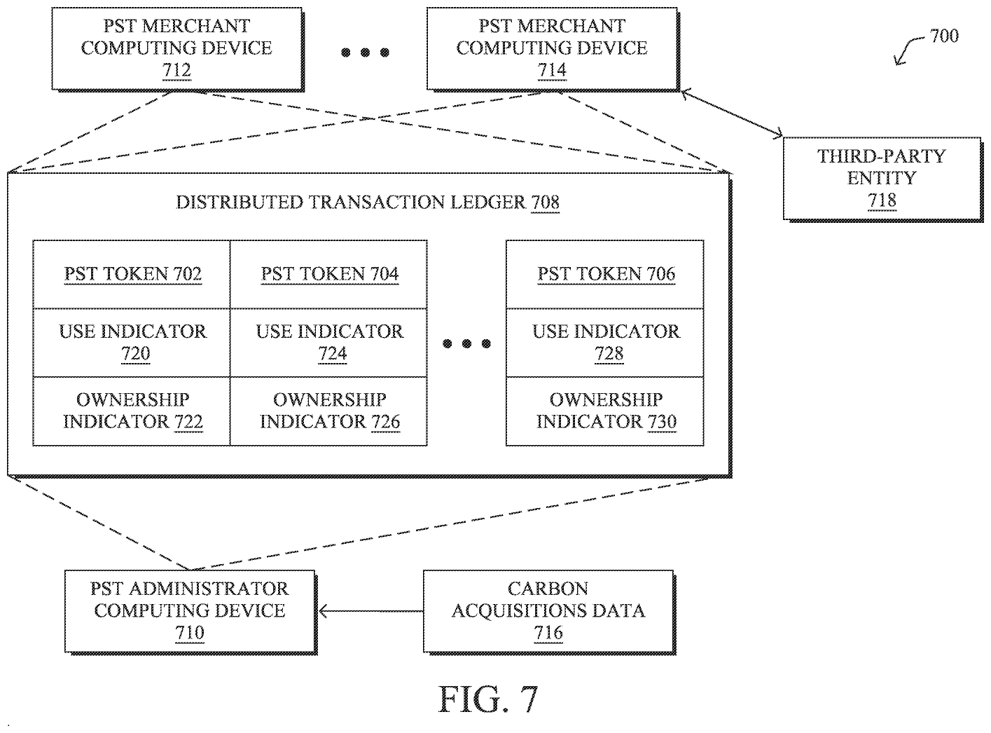

Operationally, FIG. 7 illustrates an example architecture for a secure token-based exchange of pollution credits for reduction of worldwide pollution. In particular, a system 700 for generation and exchange of a plurality PSTs 702-706 using a distributed transaction ledger 708 is shown. The system comprises a PST Administrator computing device 710 and a plurality of PST Merchant computing devices 712-714. With respect to the PSTs, they may be, in part, securities in the form of coins and in part redeemable coupons with utilitarian values. They are akin to securities with warrants wherein the warrants are not securities in themselves. Public sales of PSTs confer immediate coupon utility within a live and fully decentralized platform (coupons are not considered securities, thus not subject to registration with regulatory bodies, such as the Securities and Exchange Commission). The public can trade PST's because there are efficient liquid markets to do so, of which the platform herein is one. In fact, in addition to the platform described herein being a gateway for token holders to sell tokens, the associated merchant network (comprising the PST merchant computing devices 712-714) will redeem them in selling their goods and services, thus creating efficient, liquid markets on which to trade tokens, as is understood in the art with respect to distributed transaction ledger (or “blockchain” technology).

In the U.S., for example, for a token to be regarded as a utility and not a security, the purchaser must not be reliant on the promoter or other third party for the token to have a value. The techniques herein, therefore, allow for a fully decentralized system (i.e., not reliant on a developer's centralized servers at all), and is live at the point of token issuance. That is, the centralized server (which may be from time-to-time be described as the PST Administrator computing device 710) described herein provides certain management functions over the tokens, but does not have control over the value of the token beyond what a merchant is willing to pay for it. That is, the PST merchant computing devices 712-714 sets the value of the token when redeeming the coupon in the form of discounts on the sales of merchandise and services, or other metrics under its sole control. Further, any alternations or updates to the distributed transaction ledger 708 may need to be proposed and approved by the PST merchant computing devices 712-714 prior to being entered into the ledger.

The PST Administrator computing device 710 may be configured to maintain name and contact coordinates of all token “owners” associated with individual PST tokens 702-706, including those to whom a token holder may sell, except that when a token is exchanged for fiat it is then burned. With permission of the token owners, administrators of the PST Administrator computing device 710 may offer marketing intelligence to markets, financial institutions, non-profit enterprises, etc., where income from such activities, net of costs and a service fee, can be used as a dividend paid to participating token holders.

Carbon Credit Auctions:

With respect to generation of the PSTs, the PST administrator computing device 710 may generate the PSTs 702-706 using carbon acquisitions data 716 that is indicative of acquired CO₂ that is, as of now, currently available in different ways: (i) from offsets sold in voluntary markets, (ii) as allowances or credits in state and government regulated C&T compliance markets (typically in quarterly auctions), (iii) as “Avoided Emissions”, and (v) and as sequestered emissions. For instance, the techniques herein may source from the Northeast U.S. Regional Greenhouse Gas Initiative (RGGI) which sets a cap on short tons of carbon emissions that utilities are allowed to emit annually in the production of power over a given period (typically a few years to give them time to invest in clean energy production). The techniques herein may also be able to source from other markets, such as C&T markets in other regions and countries and from private enterprises that can sell fully validated and verifiable carbon offset tons. Notably, the terms “carbon offsets” “allowances” and “credits” are often used interchangeably, and the following description will predominantly use the term “credits.” In other words, the allowance of carbon emissions may comprise at least one of a voluntary offset of carbon emissions, a compliant offset of carbon emissions, or a renewable energy certificate (REC) for carbon emissions

Power plants operating above caps must buy credits to be in compliance, or else face being shut down. RGGI regulators use the proceeds to support clean energy development, and periodically lower the Cap threshold, thus increasing the incentive for power plants to upgrade their technology and emit less CO₂. The techniques herein, therefore, take advantage of this situation in a “planet saving” way in terms of overall carbon reduction, particularly by entering those markets to prevent credits from being used as permits to pollute. Instead, the techniques herein tie them to a consumer shopping reward in the form of redeemable tokens. Leveraging consumer spending is an accessible way to reduce greenhouse gas emissions. It scales rapidly as consumer brands adopt the techniques herein for marketing goods and services.

Under programs such as the Cap & Trade RGGI, states use quarterly auctions to sell Allowances (credits) to utilities to emit carbon above desired Caps. Utilities whose power plants require emitting tons of carbon above caps must purchase allowances in quarterly auctions to continue to operate. Basically, they pay for time to convert to cleaner technologies, as shutting them down summarily would be excessively disruptive and could lead to brownouts. From an environmental viewpoint this is basically a permit to pollute. Auctions are open to the public: anyone who qualifies and has the means may bid on and purchase carbon credits. However, this is not suitable for consumers and the public, as the sale of carbon credits occurs in bulk and at high costs.

In the case of Avoided Emissions and Sequestration carbon absorption is calculated, such as the CO₂ absorption of forests or agricultural crops and converted into tons. Preventing deforestation or continuing sustainable environmental agriculture benefits the environment. The techniques herein centrally establish, for example, using the PST administrator computing device 712, an entry point as an acquirer of credits in bulk (e.g., by the ton) and repurposes them, in fractionalized form, as PSTs.

PSTs 702-706 are representative of fractions of carbon-tons that may, in part, become digital redeemable-coupons. With the '335 patent above, such coupons were used in the creation of Points, and were sold to merchants who tie them to offers. PSTs, according to the present application, will use technology to democratize credits and make it possible for the public to engage in meaningful environmental impact as fractions of CO₂ credits, which they can trade, convert to fiat, or use the coupons attached to them as rewards when purchasing from merchants.

Rewarding Consumer Behavior:

PSTs holders will have an opportunity to register with the centralized controller herein to become “Members”, or a third-party entity 718 in its database and realize shopping benefits with the associated merchant network. For example, after linking their credit/debit card, the token holders can continue to shop as usual, without altering their behavior. Using card-link technology, the techniques herein may automatically detect when a member makes a transaction at a participating merchant and credits their account. In other words, for merchants there is no fighting consumer's wallet habits, and the system is totally seamless with any point of sale (POS) system.

In an embodiment, PST holders will be able to retain the Coin portion of their token and redeem only the coupon portion. In this embodiment the carbon tied to the coupon is transferred to the redeeming party I exchange for and offer made by the redeeming party—typically a merchant seeking to make a sale of goods or services. Thus, the value of a token prior to being stripped of the coupon is dynamically related to the extent of the offer by the redeeming party. It is expected that values will fluctuate, and will affect the public market for tokens still with coupons intact, and/or newly issued tokens. In any event, the coin portion of the token, stripped of the coupon, can continue to be traded in crypto markets. The coin portion never expires except when converted into fiat.

The Economics:

Tokens, or PSTs, are a form of common carbon ‘currency’ for all users. Tokens have at least three purposes with the single focus of incentivizing the public to join the platform herein while continuing their normal shopping habits:
1. To empower the public to retire pounds of carbon in the form of tradable coins
2. To award monetary benefits when redeeming the coupon attached to the token
3. To provide the Member with rewards as offered by merchants (discounts, gift cards, as examples).

The recent advances in distributed secure ledgers (e.g., STELLA, Ethereum, etc.) and associated technology, as well as the proliferation of the carbon credit, compounded by the cultural zeitgeist surrounding climate-change and pollution, have created a unique opportunity for environmental impact.

The platform herein uses smart contracts and wallets to create tokenized carbon credits (PSTs) for public sale. Smart contracts, for example, may include stipulations preventing PSTs from being used outside of certain parameters, and may allow PST holders to register with the platform as Members entitled to discounts offered by the merchant network.

——The Planet Saving Token Solution ——

Current top-down approaches for preventing climate-change simply aren't working well. Changing the behavior of governments, corporations, and consumers is difficult and time-consuming. The approach herein is market based, designed as an asset backed security in the form of a coin coupled with a carbon back coupon, to gain traction by rewarding consumers who shop from merchants seeking to gain and retain customers and receive credit for the carbon contained in the coupon to use toward their sustainability and climate objectives.

In addition to the '335 patent platform above, it's now time to take the consumer-driven campaign against climate-change to the next level. The democratized computing engine associated with distributed secure ledgers (e.g., Ethereum and others) has made it possible for assets, governance, and agreements to live on a publicly auditable and editable log of transactions. Secure ledger-based tokens (e.g., the PST tokens 702-706 that are part of the distributed transaction ledger 710) can facilitate reducing the carbon footprint. The following describes how the platform herein will integrate a secure ledger-based token (e.g., an ERC20 compatible Ethereum token), which will codify a carbon credit, and its long-term plan-of-attack and an overview of the '335 patent's existing infrastructure and strategy against climate-change. The platform herein democratizes carbon credits using distributed (decentralized) ledger computing engines (e.g., Ethereum). This gives power to the people to address climate change, and to be rewarded for it.

In an illustrative first embodiment, termed “Phase I”, PSTs may be based on the current cost of carbon-credits and allocated extensively for use within the platform described above in the '335 patent. That is, the platform of the '335 patent will acquire tokens as-needed and burns them, thus creating scarcity. The remainder will be sold outside the platform of the '335 patent. They may be tradeable in crypto markets or converted into fiat currency as such markets exist. Additionally, token-holders may burn them by selling them to the platform at the platform's floor price, as described below, or donating them, or redeeming them with selected merchants.

During Phase I tokenization, the '335 patent platform above shift its practice of direct acquisition of carbon credits to form Points, to purchasing PSTs that are pre-formed Points. (Note that in doing so it may continue to use the terminology “Points” so as not to confuse its Merchants and user-Members.) When a Member shops at the Merchant, the Member receives Points. This triggers the reduction of the platform's PST inventory. The platform tracks this exchange of ownership and retires the embedded token. In the end, the Merchant has paid to cause the reduction of carbon emissions as part of its marketing strategy. The Member has facilitated this reduction through shopping and been rewarded. Soli has burned the token, reducing the outstanding token balance.

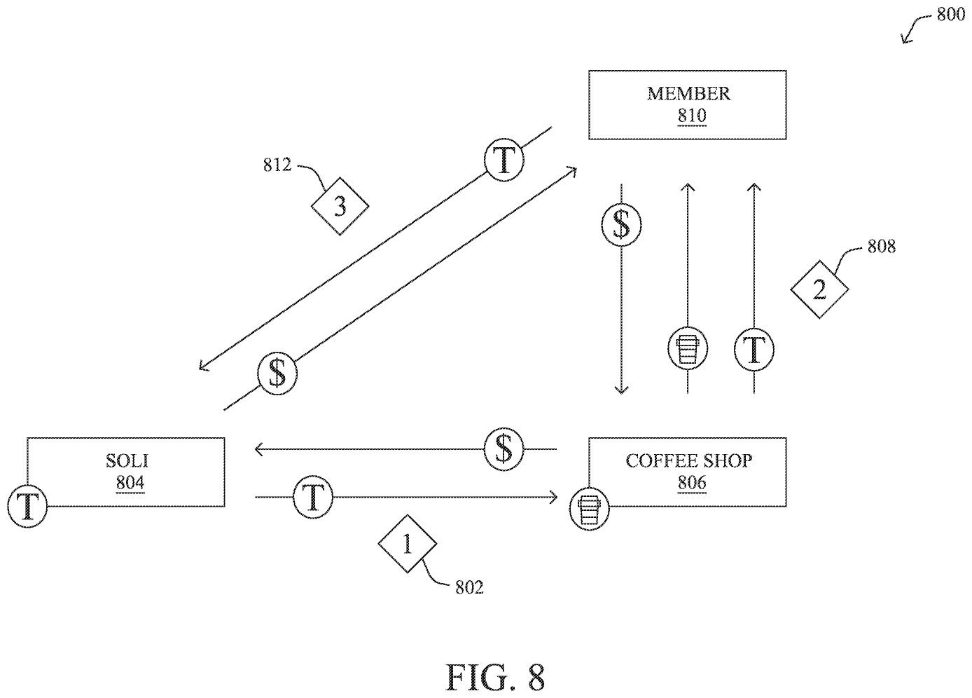

This is illustrated in FIG. 8 that shows an example flow chart 800 for Phase I. At a first step 802, the platform 804 (termed “Soli”) sells embedded PST Points to the Merchant 806. At a second step 808, a Member 810 makes a purchase and/or the Merchant 806 makes sale with Points attached. At a third step 812, the Member 810 redeems Points with Soli 804 in return for merchant rewards. The platform 804 (Soli) burns the PST, so the corresponding carbon credits are no longer available to pollute.

Upgrades to the system described in the '335 patent are required to deploy the PST. The current mobile application keeps track of Points and credits server-side. After the upgrade is complete, the mobile application will have embedded within it a fully functional ERC20 compatible Ethereum wallet. This wallet will hold all the embedded PSTs the Member earns via the platform. Members will be able to transfer their tokens out of the integrated Ethereum wallet if they wish, since the tokens will be ERC20 compatible. However, the details of the Ethereum network itself will be opaque to the every-day Member. The average Member will not have to think about ERC20 tokens at all; they will be provided with a simple interface to retire their tokens in return for rewards. This strategy allows for “average Members” and “advanced Members.” Advanced Members will have full control over their wallets, while average Members remain empowered to reduce the carbon footprint and be rewarded for their purchasing behavior.

PST Tokens fit the current '335 patent model quite nicely. Since one Point represents a static number of pounds of carbon that Merchants now purchase from the platform, the platform can instead sell Merchants PST embedded carbon Points. In turn, they are awarded by the Merchant to the Member. From the Merchant and Members' perspectives, nothing has changed from the current '335 patent system. Merchants purchase PST embedded Points; award them to the Member; who redeems them with points; and the platform burns the PST. All this movement is tracked with secure ledger (e.g., Stellar/Zilliqa, etc.) technology, preventing fraud and reuse of PSTs.

The Member truly owns the PSTs. They will be housed in an ERC20 compliant Ethereum wallet within the existing app. The novelty and technical nature of crypto makes it difficult for the public to understand PSTs and use them. Therefore, unless the Members and Merchants want to become familiar with the specifics, the details will be hidden behind an “Advanced” setting in the app. This simplifies explaining the process and the tokens to the Merchants and Members.

In a second embodiment, termed “Phase II”, another release of tokens from the Cap occurs, but at a token price based on the then cost of carbon, which might be the ‘social cost of carbon’ (a term that represents the economic cost caused by an additional ton of carbon dioxide emissions or its equivalent, which cost is higher than those in Cap & Trade as it accounts for health issues). It is expected that the cost of carbon will escalate over time and thus will be reflected in PSTs and Points pricing mechanisms as time goes on. As noted, in Phase I a Member redeeming tokens will be limited to a fixed price (which may be below market or cost).

In Phase II, the platform will remain a hub in acquiring PSTs, leading by example to fully democratize carbon credits and spearhead the technical challenges. But additionally, tokens will have a market for those seeking to receive rewards in making purchases from the platform's Merchant network. This will allow Merchants to be gateways for redemption by making exclusive offers to token holders, including discounts and special benefits enhancing token values. All such tokens would be burned. To enable this, token holders will need to register with the platform and provide certain basic information, including credit/debit card data, as their identity is not directly available via wallets. Token holders thus become Members of the platform. Technology will track and audit all transactions to avoid fraud and duplication.

The platform will continue to be a gateway for PST owners to retire their tokens directly, but at negotiated prices. We presume the competition among gateways might drive up the price of carbon credits (and PST tokens) once a market has formed. We see this as a net-victory for the planet since it will make it more expensive for companies to pollute. As an option in Phase II, under certain circumstances PSTs may be donated to Climate Remediation Foundation, Inc. (a 501 (3) (c) public charity with a focus on sustainability). All such tokens would be “burned” (used). By placing carbon credits and other climate-change instruments onto the Ethereum platform, PST can provide auditability and tracking of credits while making them more accessible to the public.

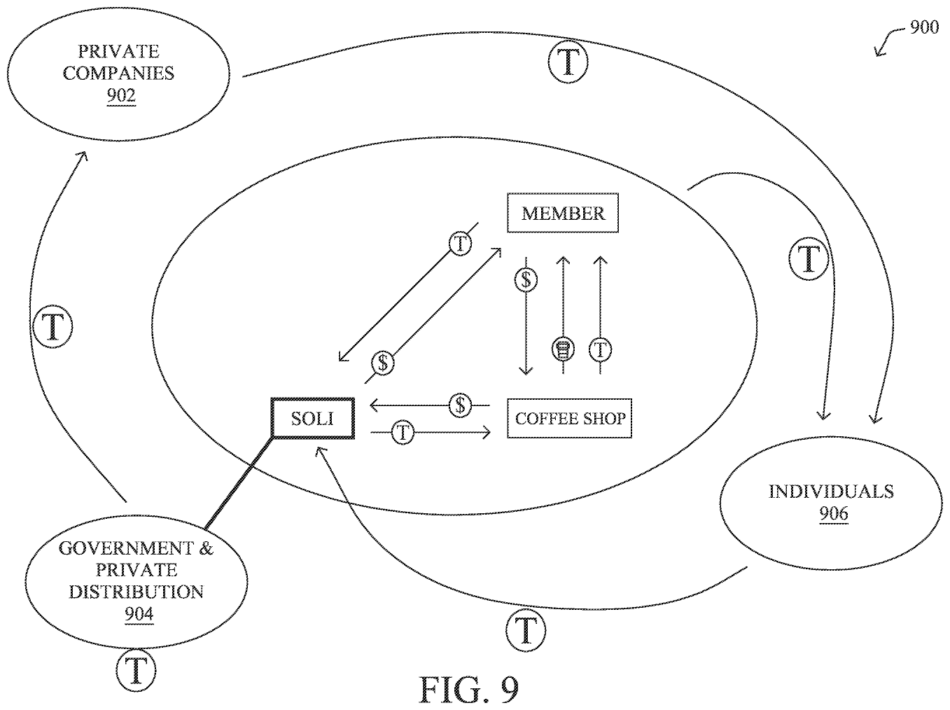

This is illustrated in FIG. 9 that shows an example flow chart 900 for Phase II. The PST market expands beyond the platform hub to include public/private trading among private companies 902, government and private distribution 904, and individuals 906. The token's representation of actual carbon is respected by all parties throughout the system. The platform may issue licenses to third parties to tokenize carbon and other environmental assets (such as those tied to water and waste), to create specialized PSTs. In such events, the platform herein remains free to purchase these third-party PSTs for adoption into the platform. This way, the platform herein takes tokens obtained externally and effectively recycles them into its own network.

In this iteration major brands might become bulk buyers of PSTs for use in marketing their offers, subject to approval by the platform (e.g., and paying appropriate fees). Whereas in Phase I the platform acts as the major user of tokens, when Phase II begins, the distribution of tokens expands exponentially.

Regional, commercial, public and private interests can adopt the token as a measure of their environmental impact. The entire carbon credit market (participants, companies, educational institutions, governments) can then use the PST as the digital asset corresponding to carbon credits. Corporations can use PSTs in lieu of purchasing Offsets for their ESG, and CSR programs. HR departments can use them as a flexible means of engaging employees in carbon remediation. Merchants will continue to purchase PST from the platform in the form of Points for marketing. However, PSTs will now have a market of their own.

Since PSTs will be pegged to a certain amount of carbon in pounds, and the price of carbon can fluctuate due to market conditions, a situation could arise in which tokens change in market value after the owner acquires them. To avoid dealing with such volatility, the platform herein may be configured to only purchase PSTs at the value fixed at the time of purchase in an Offering, less the cost of ‘gas’ (transaction fee). This way, the platform sets a floor price and assumes no risk for the fluctuations in carbon cost, and can maintain a stable business model, fighting climate change, as well as marketing to Merchants and the public.

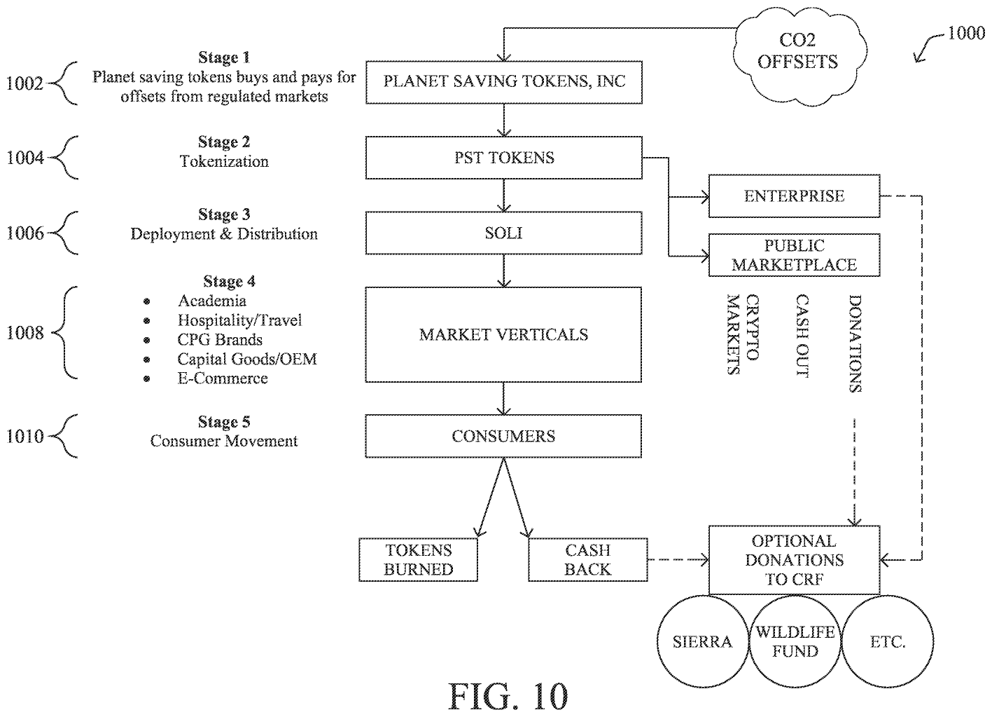

The PST platform described above is further illustrated in a flow chart 1000, as shown in FIG. 10. At a first step 1002, Stage 1, the platform herein acquires validated and numbered CO₂ offsets by the ton from C&T markets such as RGGI and the California Western Climate initiative. At a second step 1004, Stage 2, the platform forms tokens (“PST”) by fractionalizing carbon-tons (e.g., into 2-pound increments). At a third step 1006, Stage 3, the platform may sell PSTs, as examples, to:
a points-based platform (e.g., the '335 patent or “Soli”)—currently, Soli acquires offset-tons from RGGI, carves them into 2-pound pieces to create redeemable digital coupon-Points. Soli will instead use PSTs to embed into Points;
commercial enterprises that now purchase offsets for their CSR, ESG, and HR initiatives—such PSTs will effectively be burned (a smart contract will prevent their use in loyalty plans without permission); or
the public as a means of generating beneficial environmental impact (i) trading in crypto markets; (ii) cashing out with established fiat markets; (iii) earning discount from merchants; (iv) making tax deductible donations, such as to Climate Remediation Foundation, Inc.
   At a fourth step, 1008, Stage 4, PSTs have become Points (as in the '335 patent). Soli sells them to commercial and industrial enterprises for their marketing purposes to gain and retain customers and build brand as socially responsible. Five marketing verticals are targeted, each serviced by a unique infrastructure, but collectively a coalition using Points as a form of universal carbon “currency.” At a fight step, 1010, Stage 5, consumers shop and earn Points the PSTs associated with them are burned and rewards credited to the user account. At the option of the user the reward, if in cash, can be sent to a user's credit/debit card or donated, e.g., to Climate Remediation Foundation (CRF). In one embodiment, rewards remaining unused after 24 months may be donated by default to CRF.

——Secure Token Use Indicator and Ownership Indicator ——

With more detail regarding an individual PST among the plurality of PSTs 702-706 as shown in FIG. 7. In particular, the PST administrator computing device 716, after receiving the carbon acquisitions data 716 (that is indicative of an allowance of carbon emissions comprising at least one of a voluntary offset of carbon emissions, a compliant offset of carbon emissions, or a renewable energy certificate (REC) for carbon emissions), may generate token data indicative of the PSTs 702-706, where each of the token data is associated with a plurality of respective use indicators 720, 724, 728 and a plurality of respective ownership indicators 722, 726, 730. In other words, each token data for a PST 702 may have an associated use indicator 720 and ownership indicator 722. Using the use indicator 720 and ownership indicator 722 allows carbon tied to the PST 720 to be divided into parts (or sub-portions). One part is permanently attached to the token as a security in the form of tradable asset-backed carbon currency (e.g., the ownership indicator 722), the other in the form of a detachable instrument, such as a coupon (e.g., the use indicator 720). The PST currency part never expires, unless the token is redeemed for fiat in which case the token is burned/used (like turning stock back to the issuing company for cash). The coupon, or part indicated by a use indicator 720, 724, 748 can be redeemed for value with merchants making special offers as designed by them. Coupons have expiration dates and are fully retired on redemption.

Thus, by offering a discount to token holders who redeem coupons when making purchases the token holder saves or receives benefits available only to token holders. For instance, a 5% discount on a $100 purchase would save the purchaser $5.00. This effectively puts a dynamic value on the tokens with un-redeemed coupons based on the extent of discounts and offers available. Fluctuations could be fast and extreme. Since PST will act as the middleman between merchants and token holders it will be able to manage the market (with fees paid by merchants). Once coupons have been stripped from the token (or expire) it is expected that the value of the token will diminish, but not get to zero as the token itself remains backed by carbon assets (which are expected to go up in value over time as carbon costs increase). Effectively there will be two versions of tokens: those with coupons intact and those where coupons have been redeemed or expired. Appropriate nomenclature and symbols will be used to differentiate them and control markets.

The initial token will be sold as a security, as described above herein, and continue to trade as such, while the coupon is more in line with a utility, return on capital, capital gain, one-time dividend, and subject to taxation. The initial sale of a token will not price-in the value of the coupon. Hence, the aftermarket value of the token is expected to escalate in proportion to the value of coupons as placed by redeeming merchants.

In an example, an administrator of the PST system 700 may sell a security token (e.g. PST) backed by 20 lbs. Co2 for $0.50. Ten pounds permanently stay with the token while the other ten is a coupon. A qualified merchant (e.g., operating one of the PST merchant computing devices 712-714) offers a 10% discount to token holders only. The token holder redeems the coupon on making a $50 purchase. The token holder has received $5.00 of value for the investment of $0.50 (10× return). The merchant has a sale and prospectively a new customer and retains the 10 lbs. of carbon (at no cost) to apply with its climate action mandates (Paris Accord, UN Global Comact, ESG, etc.). The merchant pays PST fees to cover all transactional costs, and possibly more to cover profits for PST or a dividend to the initial token holder. It is contemplated that token holders might be able to gift or donate the coupon as long as it has not expired. For instance, if the market value of an unredeemed coupon by itself were $5.00 the holder might elect to donate it to charity as a tax deductible event.

Redemption transactions for each of the PSTs 702-706 may be entered and updated at, for example, the PST merchant computing devices 712-714, where the redemption transactions may or may not include a third party entity 718. A computing device may, after the redemption transaction has been identified (or determined) may propose an update to the distributed transaction ledger that alters a PST token associated with the redemption transaction. As is understood in the art with respect to distributed ledgers, a plurality of computing devices (that are part of the PST 700) may be required to approve of the update for the update to actually alter the redemption transaction.

Each of the use indicators 722, 726, 728 associated with respective PST tokens 702-706 may have an associated expiration dates that may only be configured by an administrator of the PST network. Expiration dates may help incentivize redemption, which is voluntary. That is, use indicators 720, 724, 728 expire after a certain time (12 months as an example) to induce early conversion. Expiration dates may be extendable only by an administrator of the PST administrator computing device 710 (or, alternatively, by a majority decision of operators of the PST merchant computing devices 712-714). Merchants can enter Token markets where PSTs are sold and buy tokens and sell the coupons attached thereto while retaining the token and carbon tied thereto for their climate action objectives. Coupons unredeemed by expiration dates may be donated to charitable organizations as tax deductible. Furthermore, token holders are not required to redeem the coupon portion and may elect to keep the carbon tied to tokens.

Token coupons can be redeemed by any merchant in the PST Merchant network at a PST merchant computing device 712-14 with the following example stipulations:
Merchants must offer a discount unique to token holders;
Merchants must register with PST (who has the sole right to accept them as a PST participating merchants, though merchants are free to opt-out of the PST program as they wish);
Merchants set the discount and terms of offers with a minimum redemption, for example, of one coupon per retail dollar of sale;
Merchant will pay fees to PST for each coupon redeemed (these fees cover, for example, gas, ETH, transactional fees, etc. tied to the transactions).

It is contemplated that PST can use portions of fees as dividends paid to token holders who submitted coupons for redemption. Furthermore, it is contemplated that a plurality of PSTs may be bundled into tons that can be sold in carbon markets with proceeds distributed to participating token holders as a cash return on capital invested, less appropriate transaction fees. This could be the case should the value of offsets escalate significantly, and/or if the coupon holder had no interest in using the coupon as a purchase discount. In such eventuality, a PST administrator would charge the coupon holder fees to cover sales and administrative costs. That is, token data may be bundled with other token data including a plurality of corresponding use indicators. When a redemption transaction occurs for the bundle, the distributed transaction ledger may be updated to alter the use indicator of the token data and a plurality of corresponding use indicators.

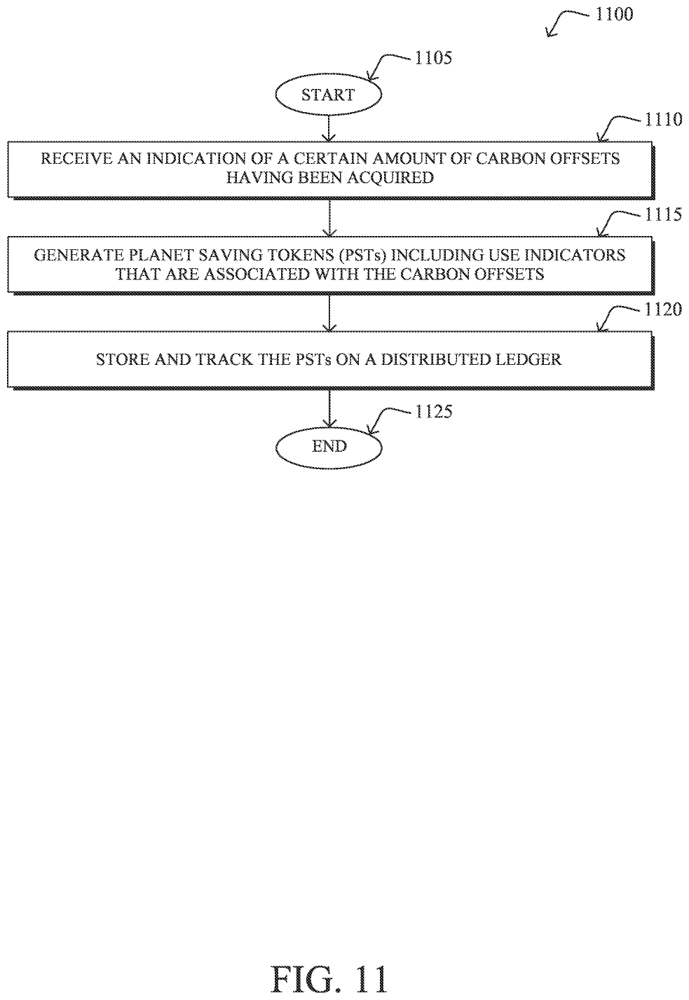

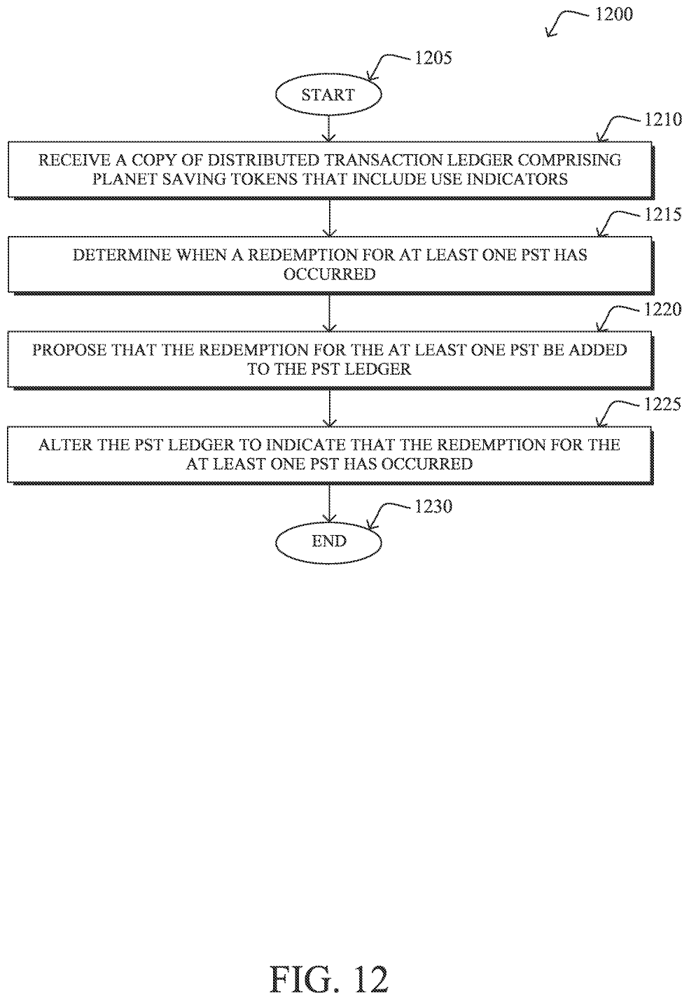

FIGS. 11-12 illustrate example simplified procedures 1100-1200 for a secure token-based exchange of pollution credits for reduction of worldwide pollution, in accordance with one or more embodiments described herein. For example, a non-generic, specifically configured device (e.g., PST Administrator computing device 710, PST merchant computing devices 712-716, computing device 1300) may perform procedures 1100-1200 by executing stored instructions (e.g., “planet saving token” process 1348).

With reference to FIG. 11, the procedure 1100 may start at step 1105, and continues to step 1110, where, as described in greater detail above, a computing device (e.g., PST Administrator computing device 710) may receive an indication of a certain amount of carbon offsets having been acquired. In particular, a computing device may receive carbon emissions acquisition data indicative of an allowance of carbon emissions. In various embodiments, the allowance of carbon emissions may comprise at least one of a voluntary offset of carbon emissions, a compliant offset of carbon emissions, or a renewable energy certificate (REC) for carbon emissions

At step 1115, as described in greater detail above, the computing device may generate PSTs including use indicators that are associated with the carbon offsets. In particular, the computing device may generate token data based on the received carbon emissions acquisition data, wherein the token data is associated with a portion of the allowance of carbon emissions and includes a use indicator and an ownership indicator. In various embodiments, the use indicator may be associated with a sub-portion of the portion of the allowance of carbon emissions. In various embodiments, the redemption transaction may be initiated by a third-party different than an owner associated with the ownership indicator.

At step 1120, the computing device may store and track the PSTs on a distributed ledger. In particular, the computing device may store the token data to a distributed transaction ledger, wherein a redemption transaction that updates the distributed transaction ledger is configured to alter the use indicator of the token data. In various embodiments, the computing device is one of a plurality of computing devices configured to store and update the token data on the distributed transaction ledger. Further, the computing device may be configured to: receive data indicative of the redemption transaction; propose an update to the distributed transaction ledger that alters the use indicator of the token data; and alter the use indicator of the token data in response to an acceptance of the update to the distributed transaction ledger. The computing device may be configured to: determine an expiration timer associated with the use indicator; and determining whether to alter the use indicator of the token data based on the data indicative of the redemption transaction satisfying the expiration timer (and, in addition, extend the expiration timer associated with the use indicator). The redemption transaction may be in response to an exchange of fiat currency. The redemption transaction may also be in compliance with at least one of Environmental, Social, and Governance (ESG) goals, the Paris Accord, or the United Nations (UN) Global Compact. Procedure 1100 then ends at step 1125.

With reference to FIG. 12, the procedure 1200 may start at step 1205, and continues to step 1210, where, as described in greater detail above, a device (e.g., a PST Merchant computing device 712, 714) may receive a copy of a distributed transaction ledger comprising PSTs that include use indicators. In particular, a computing device may receive a distributed transaction ledger comprising a plurality of token data, wherein each of the plurality of token data is associated with a portion of an allowance of carbon emissions and includes a use indicator and an ownership indicator. In various embodiments, the allowance of carbon emissions may comprise at least one of a voluntary offset of carbon emissions, a compliant offset of carbon emissions, or a renewable energy certificate (REC) for carbon emissions. In various embodiments, the computing device is one of a plurality of computing devices configured to store and update the token data on the distributed transaction ledger.

At step 1215, as described in greater detail above, the computing device may determine when a redemption for at least one PST has occurred. In particular, the computing device may determine that a redemption transaction is associated with a particular portion of the allowance of carbon emissions. The redemption transaction may be in response to an exchange of fiat currency. The redemption transaction may also be in compliance with at least one of Environmental, Social, and Governance (ESG) goals, the Paris Accord, or the United Nations (UN) Global Compact. The redemption transaction may be initiated by a third-party different than an owner associated with the ownership indicator of the particular token data

At step 1220, the device may propose that the redemption for the at least one PST be added to the PST ledger. In particular, the computing device may propose an update to the distributed transaction ledger that alters the use indicator of a particular token data to associated with the particular portion from the redemption transaction.

At step 1225, as detailed above, the computing device may alter the PST ledger to indicate that the redemption for the at least one PST has occurred. In particular, the computing device may alter the use indicator of the particular token data in response to an acceptance of the update to the distributed transaction ledger. In various embodiments, the computing device may be configured to: determine that an ownership transaction is associated with a specific portion of the allowance of carbon emissions; propose a second update to the distributed transaction ledger that alters the ownership indicator of a specific token data associated with the specific portion from the ownership transaction; and alter the ownership indicator of the specific token data in response to an acceptance of the second update to the distributed transaction ledger. Procedure 1200 then ends at step 1230.

It should be noted that while certain steps within procedures 1100-1200 may be optional as described above, the steps shown in FIGS. 11-12 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

### CONCLUDING REMARKS

The techniques described herein, therefore, provide a secure token-based exchange of pollution credits for reduction of worldwide pollution. In some aspects, the techniques herein leverage secure ledger technology (e.g., blockchain type technology) for the first time with Planet Saving Tokens as carbon backed coins with detachable carbon backed redeemable coupons to empower the public to create meaningful environmental impact by virtue of their daily shopping and be rewarded both for reducing the carbon footprint as well as monetarily. For the first time, consumers will be able to invest in incremental amounts of carbon dioxide that is normally sold to enterprises in bulk quantities to help them meet their voluntary or mandated climate action plans.

The low cost established for a Token is not seen as a bar to participation by any consumer with a desire to take part in climate remediation, and especially those in developed nations. In particular, rather than having to buy offsets in bulk, the public can purchase fractionalized tokens. An additional enticement for the public to purchase tokens is that with the platform herein, they will have coupons attached to the coin that can be redeemed for value by any merchant anywhere in the world that is a part of the planet saving merchant network.

The use of secure ledger (e.g., blockchain) technology is considered critical to enable conversion of bulk quantities of greenhouse gas emissions into tokens as fractions of bulk quantities and allow tracking greenhouse gases from their source all the way through the lifecycle of a Token to redemption and being “burned.” In essence, the carbon backing the tokens will effectively be retired as atmospheric pollutants or cause greenhouse gases to be avoided or sequestered.

Millions of citizens around the world will be able to generate meaningful environmental impact through the purchase of tokens and their subsequent coupon redemption. A key element in the techniques herein is that the carbon reduced on redemption may be shared equally by the token-holder and the redeeming merchant.

We are all in this climate problem together and we need to share responsibility. Many enterprises and merchants now voluntarily acquire carbon offsets to meet their corporate sustainability objectives and be regarded socially responsible, and in particular to meet the mandates of the Paris Agreement, CORSIA, and the UN Global compact.

By redeeming coupons tied to tokens, those entities will receive credit for a portion (e.g., one-half) of the carbon associated with the token, while the token-holder gets credit for the other portion (e.g., half). (In the present configuration, the Token will be backed by twenty pounds, but other metrics can apply, with ten pounds permanently associated with the coin and ten with the coupon) Prospectively this could mean that a merchant could redeem sufficient coupons such that it would get credit for carbon toward its sustainability objectives without having to pay for it.

An essence of the platform created herein is that merchants will provide exclusive discounts to token-holders to gain sales, build brand as socially responsible, and to do so by redeeming the coupons tied to tokens (not the entire token, thought that can happen as well).

This system results in dynamic values for the tokens as their economic worth is based on the extent of the discount offered by merchants, which are expected to be of greater value than the initial purchase price of the token.

The platform herein creates databases to capture all transactions on redeeming coupons at the point of sale. Additionally, the secure ledger (e.g., blockchain) will allow tracking tokens from their origin to redemption in immutable ledgers to avoid any duplication fraud or a hint of greenwashing.

The platform herein manages the secure ledger, handles the tokens, builds the merchant network, and facilitates the coupon redemption with merchants. Thus, the token-holding consumer can do well by doing good in lowering the carbon footprint and earning in the process. The merchant can do well by doing good by gaining sales, getting credit for carbon in meeting sustainability objectives. The platform herein does well by doing good by preventing carbon from entering the atmosphere (and being rewarded for its services).

It should be noted that while this program is designed specifically to use consumer power to help save the planet, it does not preclude merchants from buying tokens in the marketplace. However, the techniques herein may apply technology to prevent merchants from reissuing the tokens or using them or coupons attached to them in loyalty plans without the permission of the platform herein (e.g., paying fees). This will involve applying secure ledger (e.g., blockchain) technology that decentralizes the control and ownership of carbon offsets, credits and allowances, as well as to create databases that may subsequently be centralized and under the total control of the platform herein.

The platform herein, therefore:
1. Forms asset-backed security tokens with redeemable utility coupons by fractionalizing tons of greenhouse gases (GHG) such as CO₂ typically sold in compliance and voluntary markets.
2. Measures or otherwise calculates greenhouse gases associated with recycling and landfills, to create tokens as described above.
3. Monetizes the values of GHGs (principally CO₂ and methane) to form tokens and compensates sellers of offsets based on carbon emission involved in their operations.
4. Measures or otherwise calculates greenhouse gases associated with agricultural activities to create tokens as described above.
5. Monetizes the values of GHGs (principally CO₂ and methane) to form tokens and compensate farmers and forestry enterprises based on carbon emission and sequestration involved in their operations.
6. Applies secure ledger (e.g., blockchain) technology to track tokens and coupons from GHG source to redemption.
7. Creates anonymous immutable ledgers that decentralize ownership and prevent fraud and duplication of carbon claims.
8. Creates centralized non-anonymous, personally identifiable databases of token holders using electronic data from registrations, wallets and smart contracts and alternative similar tools to:
   a. manage redemption of coupons and “burning” of tokens;
   b. facilitate connecting token holders with merchants accepting coupons redemption on sales of goods and services at discount;
   c. enable sale of marketing intelligence.
9. Allows retiring the carbon backing the token permanently upon redemption or conversion into fiat.
10. Allows trading tokens in token markets as they exist.
11. Splits the credit for carbon reduction tied to the tokens between the token as a coin and a coupon for redemption by merchants—In this embodiment the merchant can receive credit for retiring carbon towards their Environmental, Social and Governmental (ESG), CORSIA, or UN Global Compact objectives effectively reducing the amount of carbon offsets it would otherwise be purchasing.
12. Allows token holders to donate their tokens to charities—In such events the tokens are effectively burned, and the donor receives tax benefits.
13. Allows merchants to buy tokens to append to their goods and services to boost sales gain and retain customers and be regarded socially responsible—In this embodiment merchant must register all tokens with the platform herein to have them validated and to allow their use in marketing (e.g., upon paying fees to the platform herein for its services).
14. Connects token holders directly with merchants while keeping the token as a decentralized asset—In such cases the platform herein will continue to gather data on the token holder to build its marketing data bases and to ensure compliance with all the use cases established by the platform herein.

While there have been shown and described illustrative embodiments above, it is to be understood that various other adaptations and modifications may be made within the spirit and scope of the embodiments herein. For example, while certain embodiments are described herein with respect to using carbon-based pollution (e.g., carbon dioxide), the techniques are not limited as such and may be used with other pollutants or environmental assets (e.g., water conservation, waste, methane, etc.) in other embodiments. For example, in another embodiment, the centralized controller buys and inventories tons of greenhouse gases (GHG) sequestered at the agricultural level. From there the same process applies as with cap and trade except that the benefits differ—the token holder get partial credit for preventing GHG from entering the atmosphere; the merchant gets credit for the remainder of the offset; the farmer is paid for agricultural practices sequestering GHG. In addition, while certain benefits in exchange for the PSTs are shown, other suitable benefits, such as renewable energy credits (RECs), production tax credits (PTCs), and similar financial incentives for clean energy, or ENERGYSTAR and similar rebates may be used, accordingly.

Illustratively, the techniques described herein may be performed by hardware, software, and/or firmware, such as in accordance with a machine learning process, which may include computer executable instructions executed by a processor or plurality of processors to perform functions relating to the techniques described herein, for example, within a single computing device or else through coordination between a plurality of computing devices across a computer network.

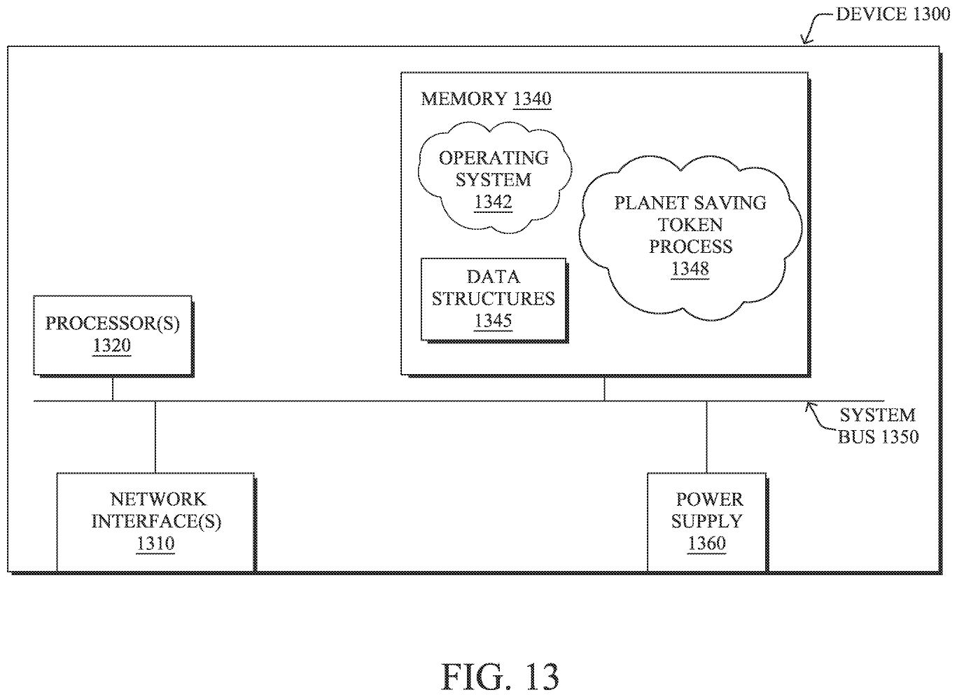

FIG. 13 is a schematic block diagram of an example computing device 1300 that may be used with one or more embodiments described herein, for example, as PST administrator computing device 710, PST merchant computing device 712, 714, a server, personal computer, cloud computing process, data center, and any other computing device that supports the operations of the techniques herein. Device 1300 comprises one or more network interfaces 1310, one or more processors 1320, and a memory 1340 interconnected by a system bus 1350, and is powered by a power supply 1360.

The network interfaces 1310 include the mechanical, electrical, and signaling circuitry for communicating data over physical or wireless links coupled to a computer network (e.g., for receiving the token data, as mentioned above). The network interfaces may be configured to transmit and/or receive data using a variety of different communication protocols.

The memory 1340 comprises a plurality of storage locations that are addressable by the processor(s) 1320 for storing software programs and data structures associated with the embodiments described herein. The processor 1320 may comprise necessary elements or logic adapted to execute the software programs and manipulate the data structures 1345. An operating system 1342, portions of which are typically resident in memory 1340 and executed by the processor(s), functionally organizes the device by, among other things, invoking operations in support of software processes and/or services executing on the device. These software processes and/or services may comprise an illustrative “planet saving token process” 1348, configured to perform one or more aspects of the techniques as described in detail above when executed by the processor(s) 1320.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

The foregoing description has been directed to specific embodiments. It will be apparent, however, that other variations and modifications may be made to the described embodiments, with the attainment of some or all of their advantages. For instance, it is expressly contemplated that certain components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
receiving, at a computing device, carbon emissions acquisition data indicative of an allowance of carbon emissions;
generating, by the computing device, token data based on the received carbon emissions acquisition data, wherein the token data is associated with a portion of the allowance of carbon emissions and includes a use indicator and an ownership indicator; and
storing, by the computing device, the token data to a distributed transaction ledger, wherein a redemption transaction that updates the distributed transaction ledger is configured to alter the use indicator of the token data.

2. The method of claim 1, further comprising:
receiving data indicative of the redemption transaction;
proposing an update to the distributed transaction ledger that alters the use indicator of the token data; and
altering the use indicator of the token data in response to an acceptance of the update to the distributed transaction ledger.

3. The method of claim 1, further comprising:
determining an expiration timer associated with the use indicator; and
determining whether to alter the use indicator of the token data based on the data indicative of the redemption transaction satisfying the expiration timer.

4. The method of claim 3, further comprising:
extending the expiration timer associated with the use indicator.

5. The method of claim 4, wherein expiration timer is extendable only by an administrator of the distributed transaction ledger.

6. The method of claim 1, further comprising:
bundling the token data with other token data including a plurality of corresponding use indicators; and
altering, based on the redemption transaction updating the distributed transaction ledger to alter the use indicator of the token data, the plurality of corresponding use indicators.

7. The method of claim 1, wherein the redemption transaction is in compliance with at least one of Environmental, Social, and Governance (ESG) goals, the Paris Accord, or the United Nations (UN) Global Compact.

8. The method of claim 1, wherein the allowance of carbon emissions comprises at least one of a voluntary offset of carbon emissions, a compliant offset of carbon emissions, a renewable energy certificate (REC), or avoided emissions and sequestration offsets for carbon emissions.

9. The method of claim 1, wherein the use indicator is associated with a sub-portion of the portion of the allowance of carbon emissions.

10. The method of claim 1, wherein the redemption transaction is initiated by a third-party different than an owner associated with the ownership indicator.

11. The method of claim 1, wherein the redemption transaction is in response to an exchange of one or more of fiat currency, frequent-flier miles, or promotional credits on an affinity card.

12. The method of claim 1, further comprising:
receiving data indicative of an ownership transaction;
proposing another update to the distributed transaction ledger that alters the ownership indicator of the token data; and
altering the ownership indicator of the token data in response to an acceptance of the other update to the distributed transaction ledger.

13. The method of claim 12, wherein the ownership transaction is in response to an exchange of one or more of fiat currency, frequent-flier miles, or promotional credits on an affinity card.

14. The method of claim 1, wherein the computing device is one of a plurality of computing devices configured to store and update the token data on the distributed transaction ledger.

15. A method, comprising:
receiving, at a computing device, a distributed transaction ledger comprising a plurality of token data, wherein each of the plurality of token data is associated with a portion of an allowance of carbon emissions and includes a use indicator and an ownership indicator;
determining, by the computing device, that a redemption transaction is associated with a particular portion of the allowance of carbon emissions;
proposing, by the computing device, an update to the distributed transaction ledger that alters the use indicator of a particular token data associated with the particular portion from the redemption transaction; and
altering, by the computing device, the use indicator of the particular token data in response to an acceptance of the update to the distributed transaction ledger.

16. The method of claim 15, wherein the redemption transaction is in compliance with at least one of Environmental, Social, and Governance (ESG) goals, the Paris Accord, or the United Nations (UN) Global Compact.

17. The method of claim 15, wherein the allowance of carbon emissions comprises at least one of a voluntary offset of carbon emissions, a compliant offset of carbon emissions, a renewable energy certificate (REC) for carbon emissions, or avoided emissions and sequestration offsets for carbon emissions.

18. The method of claim 15, wherein the redemption transaction is initiated by a third-party different than an owner associated with the ownership indicator of the particular token data.

19. The method of claim 15, wherein the redemption transaction is in response to an exchange one or more of fiat currency, frequent-flier miles, or promotional credits on an affinity card.

20. The method of claim 15, further comprising:
determining that an ownership transaction is associated with a specific portion of the allowance of carbon emissions;
proposing a second update to the distributed transaction ledger that alters the ownership indicator of a specific token data associated with the specific portion from the ownership transaction; and
altering the ownership indicator of the specific token data in response to an acceptance of the second update to the distributed transaction ledger.
